(19) United States
(12) Patent Application Publication
(10) Pub. No.: US 2024/0155677 A1
(43) Pub. Date: May 9, 2024

(54) DOWNLINK TRANSMISSION AND DETECTION FOR UPLINK TRANSMISSIONS IN SEMI-STATIC CHANNEL ACCESS

(71) Applicant: QUALCOMM Incorporated, San Diego, CA (US)

(72) Inventors: Shaozhen GUO, Beijing (CN); Jing SUN, San Diego, CA (US); Changlong XU, Beijing (CN); Xiaoxia ZHANG, San Diego, CA (US)

(21) Appl. No.: 18/548,960

(22) PCT Filed: Apr. 23, 2021
(86) PCT No.: PCT/CN2021/089310

§ 371 Date: Sep. 5, 2023

(51) Int. Cl. H04W 74/0808; H04W 74/00

(52) U.S. Cl. CPC H04W 74/0808; H04W 74/006

(57) ABSTRACT

Methods and devices for downlink (DL) control channel communications operating in a semi-static channel access mode in a shared frequency band are provided. In one aspect, a method is performed by a base station (BS) and includes: transmitting, based on a first configuration during a first period, a first downlink (DL) control signal, where the first configuration is based on the first period associated with a first channel occupancy signal (COT) type; and transmitting, based on a second configuration during a second period, a second DL control signal, where the second configuration is based on the second period associated with a second COT type different from the first COT type, and where the second configuration is different from the first configuration.

### TECHNICAL FIELD

This application relates to wireless communication systems, and more particularly to downlink (DL) transmission and detection schemes in semi-static channel access scenarios with user equipment (UE)-initiated channel occupancy time (COT) sharing.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE).

To meet the growing demands for expanded mobile broadband connectivity, wireless communication technologies are advancing from the long term evolution (LTE) technology to a next generation new radio (NR) technology, which may be referred to as 5^{th} Generation (5G). For example, NR is designed to provide a lower latency, a higher bandwidth or a higher throughput, and a higher reliability than LTE. NR is designed to operate over a wide array of spectrum bands, for example, from low-frequency bands below about 1 gigahertz (GHz) and mid-frequency bands from about 1 GHz to about 6 GHz, to high-frequency bands such as mmWave bands. NR is also designed to operate across different spectrum types, from licensed spectrum to unlicensed and shared spectrum. Spectrum sharing enables operators to opportunistically aggregate spectrums to dynamically support high-bandwidth services. Spectrum sharing can extend the benefit of NR technologies to operating entities that may not have access to a licensed spectrum.

One approach to avoiding collisions when communicating in a shared spectrum or an unlicensed spectrum is to use a listen-before-talk (LBT) procedure to ensure that the shared channel is clear before transmitting a signal in the shared channel. The operations or deployments of NR in an unlicensed spectrum is referred to as NR-U. In NR-U, a transmitting node (e.g., a BS or a UE) may perform a category 1 (CAT1) LBT (e.g., no LBT measurement), a category 2 (CAT2) LBT, or a category 4 (CAT4) LBT prior to transmitting a communication signal in an unlicensed frequency band. For example, a BS may acquire a COT in an unlicensed frequency band by performing a CAT4 LBT. The BS may schedule one or more UEs for UL and/or DL communication within the BS's COT. In addition, the BS may schedule one or more UEs for UL communication outside of the BS's COT. A UE with an UL schedule within the BS's COT may perform a CAT2 LBT prior to the scheduled UL transmission. A UE with an UL schedule outside of the BS's COT may perform a CAT4 LBT prior to the scheduled UL transmission.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

Aspects of the present disclosure include mechanisms for transmitting and detecting downlink (DL) control channel signals in a semi-static channel access scenario where UEs of different UE-type configurations are communicating in a shared frequency band. In some aspects, the mechanisms and schemes provided herein allow a BS to transmit DL control information (e.g., DCI) such that UEs having a first UE-type configuration can detect the DL control information, but UEs having a second UE-type configuration cannot detect the DL control information. In some aspects, the DL control information may be scrambled, encoded, or otherwise modified based on a UE-type configuration of the intended recipients of the DL control information. Further, the mechanisms described herein may allow a UE having a first UE-type configuration to detect or decode DL control information transmitted in a group-common PDCCH, while a UE having a second UE-type configuration may not detect or decode the DL control information in the GC-PDCCH.

One aspect of the present disclosure includes a method for wireless communication performed by a base station (BS). The method includes transmitting, based on a first configuration during a first period, a first downlink (DL) control signal, where the first configuration is based on the first period associated with a first channel occupancy signal (COT) type; and transmitting, based on a second configuration during a second period, a second DL control signal, where the second configuration is based on the second period associated with a second COT type different from the first COT type, and where the second configuration is different from the first configuration.

One aspect of the present disclosure includes a method for wireless communication performed by a user equipment (UE). The method includes receiving a downlink (DL) control channel signal. The method also includes processing the DL control channel signal based on a first UE-type configuration. The method also includes processing the DL control channel signal based on a second UE-type configuration different from the first UE-type configuration. The method also includes obtaining DL control information from the DL control channel signal from the processing based on the first UE-type configuration or the processing based on the second UE-type configuration.

One aspect of the present disclosure includes a base station (BS). The BS includes a transceiver; and a processor in communication with the transceiver and configured to cause the transceiver to transmit, based on a first configuration during a first period, a first downlink (DL) control signal, where the first configuration is based on the first period associated with a first channel occupancy signal (COT) type; and transmit, based on a second configuration during a second period, a second DL control signal, where the second configuration is based on the second period associated with a second COT type different from the first COT type, and where the second configuration is different from the first configuration.

One aspect of the present disclosure includes a user equipment (UE). The UE includes a transceiver. The UE also includes a processor in communication with the transceiver and configured to cause the transceiver to receive a downlink (DL) control channel signal, where the processor is further configured to process the DL control channel signal based on a first UE-type configuration; process the DL control channel signal based on a second UE-type configuration different from the first UE-type configuration; and obtain DL control information from the DL control channel signal from the processing based on the first UE-type configuration or the processing based on the second UE-type configuration.

One aspect of the present disclosure includes a base station (BS). The BS includes means for transmitting, based on a first configuration during a first period, a first downlink (DL) control signal, where the first configuration is based on the first period associated with a first channel occupancy signal (COT) type; and means for transmitting, based on a second configuration during a second period, a second DL control signal, where the second configuration is based on the second period associated with a second COT type different from the first COT type, and where the second configuration is different from the first configuration.

One aspect of the present disclosure includes a user equipment (UE). The UE includes means for receiving a downlink (DL) control channel signal. The UE also includes means for processing the dl control channel signal based on a first user equipment (UE)-type configuration. The UE also includes means for processing the DL control channel signal based on a second UE-type configuration different from the first UE-type configuration. The UE also includes means for obtaining DL control information from the DL control channel signal from the processing based on the first UE-type configuration or the processing based on the second UE-type configuration.

Other aspects, features, and embodiments will become apparent to those of ordinary skill in the art, upon reviewing the following description of specific, exemplary aspects in conjunction with the accompanying figures. While features may be discussed relative to certain aspects and figures below, all aspects can include one or more of the advantageous features discussed herein. In other words, while one or more aspects may be discussed as having certain advantageous features, one or more of such features may also be used in accordance with the various aspects discussed herein. In similar fashion, while exemplary aspects may be discussed below as device, system, or method aspects it should be understood that such exemplary aspects can be implemented in various devices, systems, and methods.

### BRIEF DESCRIPTION OF THE DRAWINGS

FIG. 1 illustrates a wireless communication network according to some aspects of the present disclosure.

FIG. 2 illustrates a radio frame structure according to some aspects of the present disclosure.

FIG. 3A illustrates an example of a wireless communications network that supports medium sharing across multiple network operating entities according to some aspects of the present disclosure.

FIG. 3B illustrates a frame based equipment (FBE) communication scheme according to some aspects of the present disclosure.

FIG. 4 is a timing diagram illustrating a scheme for sharing a channel occupancy time (COT) acquired by a base station (BS) according to some embodiments of the present disclosure.

FIG. 5 is a timing diagram illustrating a scheme for sharing a COT acquired by a user equipment (UE) according to some embodiments of the present disclosure.

FIG. 6 is a timing diagram illustrating a scheme for transmitting and detecting downlink (DL) transmissions using semi-static channel access according to some embodiments of the present disclosure.

FIG. 7 is a timing diagram illustrating a scheme for transmitting and detecting DL transmissions using semi-static channel access according to some embodiments of the present disclosure.

FIG. 8 is a timing diagram illustrating a scheme for transmitting and detecting DL transmissions using semi-static channel access according to some embodiments of the present disclosure.

FIG. 9 illustrates a scheme for transmitting and detecting DL transmissions using semi-static channel access according to some embodiments of the present disclosure.

FIG. 10 illustrates a scheme for transmitting and detecting DL transmissions using semi-static channel access according to some embodiments of the present disclosure.

FIG. 11 illustrates a scheme for transmitting and detecting DL transmissions using semi-static channel access according to some embodiments of the present disclosure.

FIG. 12 illustrates a scheme for transmitting and detecting DL transmissions using semi-static channel access according to some embodiments of the present disclosure.

FIG. 13 is a block diagram of a UE according to some aspects of the present disclosure.

FIG. 14 is a block diagram of an exemplary BS according to some aspects of the present disclosure.

FIG. 15 is a flow diagram of a communication method according to some aspects of the present disclosure.

FIG. 16 is a flow diagram of a communication method according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various aspects, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, Global System for Mobile Communications (GSM) networks, 5^{th} Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the UMTS mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with a Ultra-high density (e.g., ˜1M nodes/km²), ultra-low complexity (e.g., ˜10 s of bits/sec), ultra-low energy (e.g., ˜10+ years of battery life), and deep coverage with the capability to reach challenging locations; (2) including time-stringent control with strong security to safeguard sensitive personal, financial, or classified information, ultra-high reliability (e.g., ˜99.9999% reliability), ultra-low latency (e.g., ˜1 ms), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

A 5G NR communication system may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 5, 10, 20 MHz, and the like bandwidth (BW). For other various outdoor and small cell coverage deployments of TDD greater than 3 GHz, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 500 MHz BW. In certain aspects, frequency bands for 5G NR are separated into two different frequency ranges, a frequency range one (FR1) and a frequency range two (FR2). FR1 bands include frequency bands at 7 GHz or lower (e.g., between about 410 MHz to about 7125 MHz). FR2 bands include frequency bands in mmWave ranges between about 24.25 GHz and about 52.6 GHz. The mmWave bands may have a shorter range, but a higher bandwidth than the FR1 bands. Additionally, 5G NR may support different sets of subcarrier spacing for different frequency ranges.

The scalable numerology of the 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink/downlink scheduling information, data, and acknowledgement in the same subframe. The self-contained integrated subframe supports communications in unlicensed or contention-based shared spectrum, adaptive uplink/downlink that may be flexibly configured on a per-cell basis to dynamically switch between UL and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

The present application describes mechanisms for indicating and detecting downlink (DL) transmissions in a semi-static channel access mode, which may also be referred to as a frame based equipment (FBE) mode over a shared radio frequency band or an unlicensed band. The present application may be suitable for use in new radio-unlicensed (NR-U) deployments. In some instances, there may be user equipments (UEs) having different UE-type configurations operating in a network, such as a NR-U network. For example, some UEs may operate using a more recent UE-type configuration, such as a more recent release or revision of a wireless protocol. In some aspects, a first UE having a first UE-type configuration may be configured to initiate a channel occupancy time (COT), and to share a portion of the COT with a BS. However, other UEs in the network may be operating with a second UE-type configuration for which sharing of UE-initiated COTs with the BS are not enabled. In some instances, a UE having a first UE-type configuration, which may be referred to as an enhanced UE configuration, acquires a COT, and shares a portion of the COT with the BS. When the BS transmits a DL communication, such as a DL control signal, a second UE having the second UE-type configuration may erroneously assume that the DL communication is sent in a BS-initiated COT. Based on this erroneous determination, the second UE may attempt to perform an UL transmission to share the COT, which is not intended for sharing with the second UE. In an example, UEs of the second UE-type configuration may be 3GPP Release 16 UEs.

As described in detail below, the present disclosure provides solutions to these issues. For example, in some instances a base station (BS) is configured to transmit DL control signals (e.g., DCI) such that a UE having a second UE-type configuration for which UE-initiated COT sharing is not enabled does not decode, descramble, or otherwise detect the DL control signals, while a UE having a first UE-type configuration (i.e. UE-initiated COT sharing enabled) can decode, descramble, or otherwise detect the DL control signals. Accordingly, the BS can transmit DL control signals in a shared portion of a UE-initiated COT without causing a UE having the second UE-type configuration to attempt to share the COT. In some aspects, the BS is configured to transmit different DL control signals in a single COT, where a scrambling ID or monitoring occasion associated with the DL control signal is determined based on the UE-type configuration of the intended UE recipients of the DL control signals. In other aspects, the BS may transmit a single DL control signal in a COT, and modify the DL control signal (e.g., RNTI scrambling, scrambling ID, cyclic redundancy check (CRC) polynomial, etc.) based on the UE-type configuration of the intended UE recipient. In this example, the UE having the first UE-type configuration may be configured to perform two processing operations to obtain DL control information. In some aspects, the two processing operations may include two blind decodings for each physical downlink control channel (PDCCH) candidate. In other aspects, the two processing operations may include two CRC computations, two CRC descramblings, and/or two CRC checks with a single blind decoding for each PDCCH candidate, and/or other processing operations described herein.

The schemes and mechanisms described herein advantageously facilitate UE-initiated COT sharing in networks having a variety of UE-type configurations present and active, such that a BS can transmit DL communications in a semi-static channel access mode based on UE-type configurations of the UEs that are the intended recipients of the DL communications.

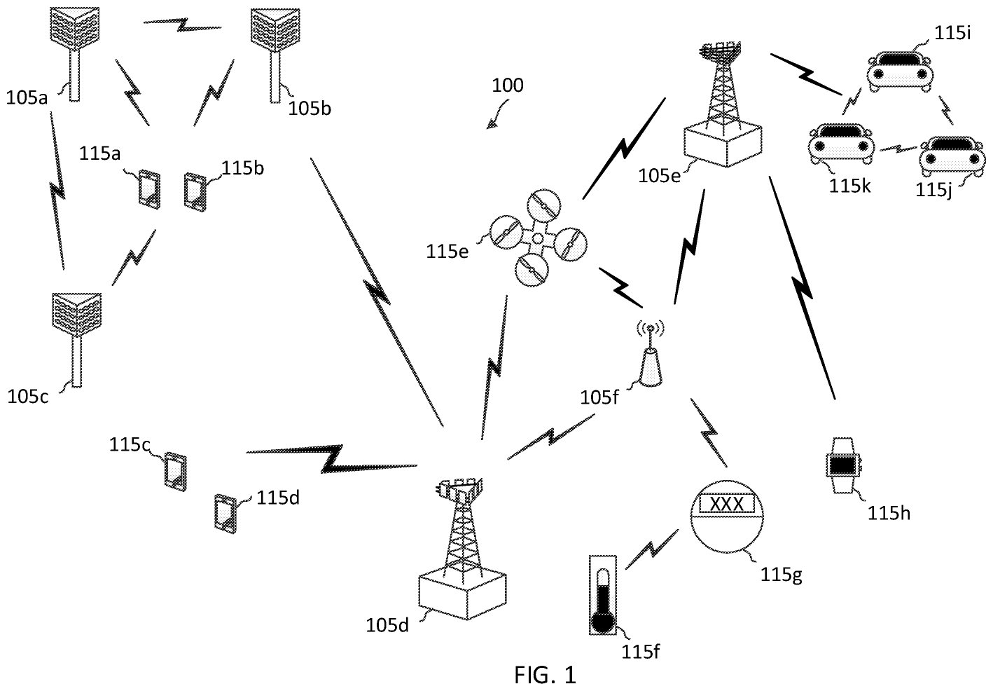

FIG. 1 illustrates a wireless communication network 100 according to some aspects of the present disclosure. The network 100 may be a 5G network. The network 100 includes a number of base stations (BSs) 105 (individually labeled as 105a, 105b, 105c, 105d, 105e, and 105f) and other network entities. ABS 105 may be a station that communicates with UEs 115 and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used.

ABS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. ABS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The UEs 115i-115k are examples of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105a-105c may serve the UEs 115a and 115b using 3D beamforming and coordinated spatial techniques, such as coordinated multipoint (CoMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of a gNB or an access node controller (ANC)) may interface with the core network through backhaul links (e.g., NG-C, NG-U, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support time-stringent communications with ultra-reliable and redundant links for time-stringent devices, such as the UE 115e, which may be a drone. Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-step-size configurations by communicating with another user device which relays its information to the network, such as the UE 115f communicating temperature measurement information to the smart meter, the UE 115g, which is then reported to the network through the small cell BS 105f. The network 100 may also provide additional network efficiency through dynamic, low-latency TDD/FDD communications, such as vehicle-to-vehicle (V2V), vehicle-to-everything (V2X), cellular-V2X (C-V2X) communications between a UE 115i, 115j, or 115k and other UEs 115, and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands. In other instances, the subcarrier spacing and/or the duration of TTIs may be scalable.

In some aspects, the BSs 105 can assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes or slots, for example, about 10. Each slot may be further divided into mini-slots. In a FDD mode, simultaneous UL and DL transmissions may occur in different frequency bands. For example, each subframe includes an UL subframe in an UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information—reference signals (CSI-RSs) to enable a UE 115 to estimate a DL channel. Similarly, a UE 115 may transmit sounding reference signals (SRSs) to enable a BS 105 to estimate an UL channel. Control information may include resource assignments and protocol controls. Data may include protocol data and/or operational data. In some aspects, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In some aspects, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining system information (RMSI), and other system information (OSI)) to facilitate initial network access. In some instances, the BSs 105 may broadcast the PSS, the SSS, and/or the MIB in the form of synchronization signal block (SSBs) and may broadcast the RMSI and/or the OSI over a physical downlink shared channel (PDSCH). The MIB may be transmitted over a physical broadcast channel (PBCH).

In some aspects, a UE 115 attempting to access the network 100 may perform an initial cell search by detecting a PSS from a BS 105. The PSS may enable synchronization of period timing and may indicate a physical layer identity value. The UE 115 may then receive a SSS. The SSS may enable radio frame synchronization, and may provide a cell identity value, which may be combined with the physical layer identity value to identify the cell. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical UL control channel (PUCCH), physical UL shared channel (PUSCH), power control, and SRS.

After obtaining the MIB, the RMSI and/or the OSI, the UE 115 can perform a random access procedure to establish a connection with the BS 105. In some examples, the random access procedure may be a four-step random access procedure. For example, the UE 115 may transmit a random access preamble and the BS 105 may respond with a random access response. The random access response (RAR) may include a detected random access preamble identifier (ID) corresponding to the random access preamble, timing advance (TA) information, an UL grant, a temporary cell-radio network temporary identifier (C-RNTI), and/or a backoff indicator. Upon receiving the random access response, the UE 115 may transmit a connection request to the BS 105 and the BS 105 may respond with a connection response. The connection response may indicate a contention resolution. In some examples, the random access preamble, the RAR, the connection request, and the connection response can be referred to as message 1 (MSG1), message 2 (MSG2), message 3 (MSG3), and message 4 (MSG4), respectively. In some examples, the random access procedure may be a two-step random access procedure, where the UE 115 may transmit a random access preamble and a connection request in a single transmission and the BS 105 may respond by transmitting a random access response and a connection response in a single transmission.

After establishing a connection, the UE 115 and the BS 105 can enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The scheduling grants may be transmitted in the form of DL control information (DCI). The BS 105 may transmit a DL communication signal (e.g., carrying data) to the UE 115 via a PDSCH according to a DL scheduling grant. The UE 115 may transmit an UL communication signal to the BS 105 via a PUSCH and/or PUCCH according to an UL scheduling grant. The connection may be referred to as an RRC connection. When the UE 115 is actively exchanging data with the BS 105, the UE 115 is in an RRC connected state.

In an example, after establishing a connection with the BS 105, the UE 115 may initiate an initial network attachment procedure with the network 100. The BS 105 may coordinate with various network entities or fifth generation core (5GC) entities, such as an access and mobility function (AMF), a serving gateway (SGW), and/or a packet data network gateway (PGW), to complete the network attachment procedure. For example, the BS 105 may coordinate with the network entities in the 5GC to identify the UE, authenticate the UE, and/or authorize the UE for sending and/or receiving data in the network 100. In addition, the AMF may assign the UE with a group of tracking areas (TAs). Once the network attach procedure succeeds, a context is established for the UE 115 in the AMF. After a successful attach to the network, the UE 115 can move around the current TA. For tracking area update (TAU), the BS 105 may request the UE 115 to update the network 100 with the UE 115's location periodically. Alternatively, the UE 115 may only report the UE 115's location to the network 100 when entering a new TA. The TAU allows the network 100 to quickly locate the UE 115 and page the UE 115 upon receiving an incoming data packet or call for the UE 115.

In some aspects, the BS 105 may communicate with a UE 115 using hybrid automatic repeat request (HARQ) techniques to improve communication reliability, for example, to provide an ultra-reliable low-latency communication (URLLC) service. The BS 105 may schedule a UE 115 for a PDSCH communication by transmitting a DL grant in a PDCCH. The BS 105 may transmit a DL data packet to the UE 115 according to the schedule in the PDSCH. The DL data packet may be transmitted in the form of a transport block (TB). If the UE 115 receives the DL data packet successfully, the UE 115 may transmit a HARQ acknowledgement (ACK) to the BS 105. Conversely, if the UE 115 fails to receive the DL transmission successfully, the UE 115 may transmit a HARQ negative-acknowledgement (NACK) to the BS 105. Upon receiving a HARQ NACK from the UE 115, the BS 105 may retransmit the DL data packet to the UE 115. The retransmission may include the same coded version of DL data as the initial transmission. Alternatively, the retransmission may include a different coded version of the DL data than the initial transmission. The UE 115 may apply soft-combining to combine the encoded data received from the initial transmission and the retransmission for decoding. The BS 105 and the UE 115 may also apply HARQ for UL communications using substantially similar mechanisms as the DL HARQ.

In some aspects, the network 100 may operate over a system BW or a component carrier (CC) BW. The network 100 may partition the system BW into multiple BWPs (e.g., portions). A BS 105 may dynamically assign a UE 115 to operate over a certain BWP (e.g., a certain portion of the system BW). The assigned BWP may be referred to as the active BWP. The UE 115 may monitor the active BWP for signaling information from the BS 105. The BS 105 may schedule the UE 115 for UL or DL communications in the active BWP. In some aspects, a BS 105 may assign a pair of BWPs within the CC to a UE 115 for UL and DL communications. For example, the BWP pair may include one BWP for UL communications and one BWP for DL communications.

In some aspects, the network 100 may operate over a shared channel, which may include shared frequency bands or unlicensed frequency bands. For example, the network 100 may be an NR-unlicensed (NR-U) network. The BSs 105 and the UEs 115 may be operated by multiple network operating entities. To avoid collisions, the BSs 105 and the UEs 115 may employ a listen-before-talk (LBT) procedure to monitor for transmission opportunities (TXOPs) in the shared channel. For example, a transmitting node (e.g., a BS 105 or a UE 115) may perform an LBT prior to transmitting in the channel. When the LBT passes, the transmitting node may proceed with the transmission. When the LBT fails, the transmitting node may refrain from transmitting in the channel. In an example, the LBT may be based on energy detection. For example, the LBT results in a pass when signal energy measured from the channel is below a threshold. Conversely, the LBT results in a failure when signal energy measured from the channel exceeds the threshold. In another example, the LBT may be based on signal detection. For example, the LBT results in a pass when a channel reservation signal (e.g., a predetermined preamble signal) is not detected in the channel. In some aspects, the network 100 may utilize an FBE-based contention scheme, which may also be referred to as a semi-static channel access scheme, for sharing a radio channel among multiple BSs 105 and/or UEs 115 of different network operating entities and/or different radio access technologies (RATs). In some aspects, a BS 105 and/or a UE 115 may be configured to initiate or acquire a channel occupancy time (COT) in the shared frequency band. Further, the BS 105 and/or a UE 115 may be configured to share a portion of the acquired COT with the UE 115 or the BS 105.

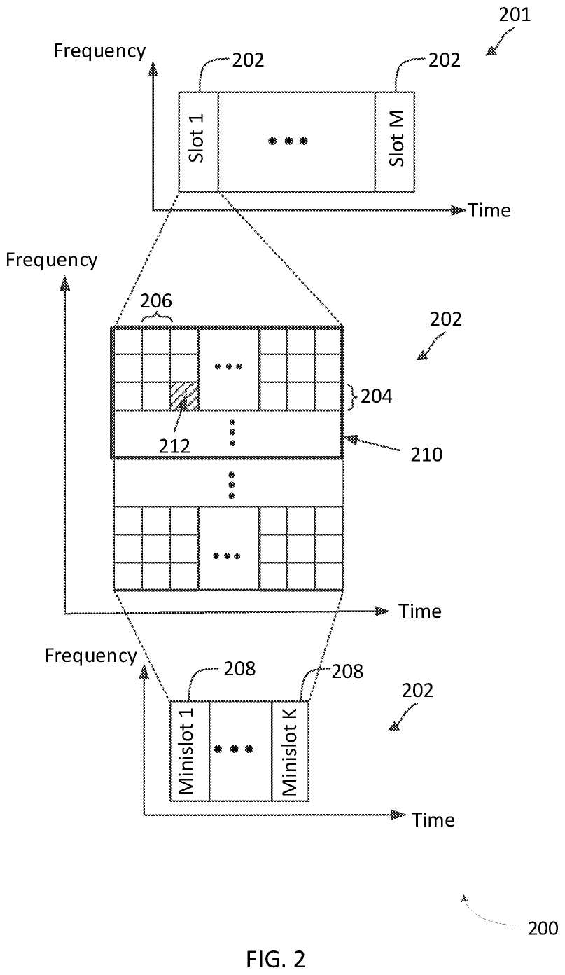

FIG. 2 is a timing diagram illustrating a radio frame structure 200 according to some aspects of the present disclosure. The radio frame structure 200 may be employed by BSs such as the BSs 105 and UEs such as the UEs 115 in a network such as the network 100 for communications. In particular, the BS may communicate with the UE using time-frequency resources configured as shown in the radio frame structure 200. In FIG. 2, the x-axes represent time in some arbitrary units and the y-axes represent frequency in some arbitrary units. The transmission frame structure 200 includes a radio frame 201. The duration of the radio frame 201 may vary depending on the aspects. In an example, the radio frame 201 may have a duration of about ten milliseconds. The radio frame 201 includes M number of slots 202, where M may be any suitable positive integer. In an example, M may be about 10.

Each slot 202 includes a number of subcarriers 204 in frequency and a number of symbols 206 in time. The number of subcarriers 204 and/or the number of symbols 206 in a slot 202 may vary depending on the aspects, for example, based on the channel bandwidth, the subcarrier spacing (SCS), and/or the CP mode. One subcarrier 204 in frequency and one symbol 206 in time forms one resource element (RE) 212 for transmission. A resource block (RB) 210 is formed from a number of consecutive subcarriers 204 in frequency and a number of consecutive symbols 206 in time.

In an example, a BS (e.g., BS 105 in FIG. 1) may schedule a UE (e.g., UE 115 in FIG. 1) for UL and/or DL communications at a time-granularity of slots 202 or mini-slots 208. Each slot 202 may be time-partitioned into K number of mini-slots 208. Each mini-slot 208 may include one or more symbols 206. The mini-slots 208 in a slot 202 may have variable lengths. For example, when a slot 202 includes N number of symbols 206, a mini-slot 208 may have a length between one symbol 206 and (N−1) symbols 206. In some aspects, a mini-slot 208 may have a length of about two symbols 206, about four symbols 206, or about seven symbols 206. In some examples, the BS may schedule UE at a frequency-granularity of a resource block (RB) 210 (e.g., including about 12 subcarriers 204).

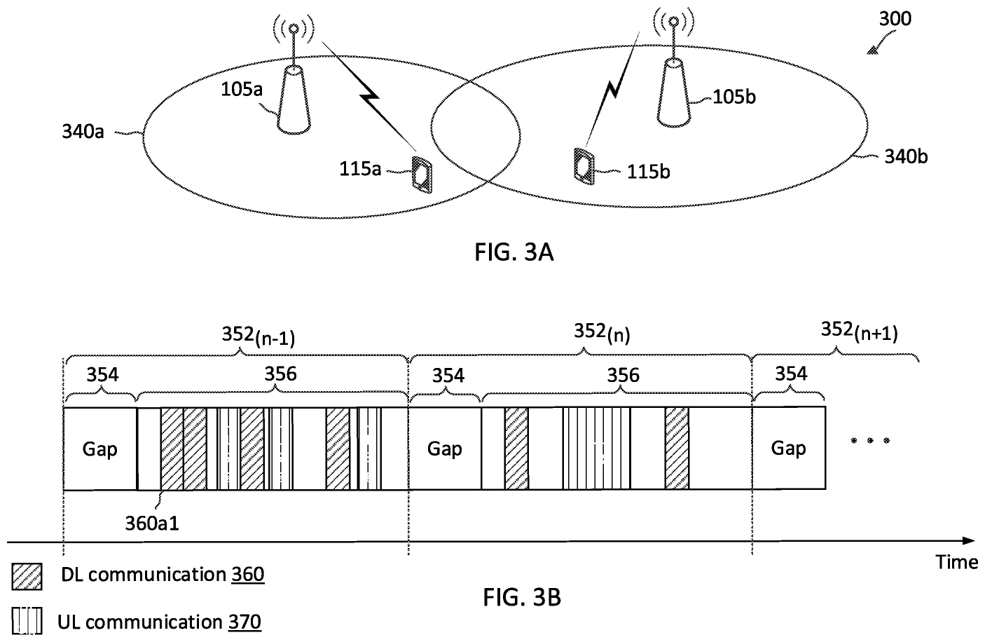

FIGS. 3A and 3B collectively illustrate FBE-based communications over a radio frequency channel (e.g., in a shared radio frequency band or an unlicensed band) for communication. In some aspects, FBE-based communications may be referred to as semi-static channel access communications. FIG. 3A illustrates an example of a wireless communications network 300 that supports medium sharing across multiple network operating entities according to some aspects of the present disclosure. The network 300 may correspond to a portion of the network 100. FIG. 3A illustrates two BSs 105 (shown as BS 105a and BS 105b) and two UEs 115 (shown as UE 115a and UE 115b) for purposes of simplicity of discussion, though it will be recognized that aspects of the present disclosure may scale to many more UEs 115 and/or BSs 105. The BSs 105 and the UEs 115 may be similar to the BSs 105 and the UEs 115 of FIG. 1. FIG. 3B illustrates an FBE communication scheme 350 according to some aspects of the present disclosure. The BS 105 and the UE 115 may communicate with each other as shown in the scheme 350. In FIG. 3B, the x-axis represents time in some arbitrary units, and the y-axis represents frequency in some arbitrary units.

Referring to FIG. 3A, in the network 300, the BS 105a serves the UE 115a in a serving cell or a coverage area 340a, while the BS 105b serves the UE 115b in a serving cell or a coverage area 340b. The BS 105a and the BS 105b may communicate with the UE 115a and the UE 115b in the same frequency channel (e.g., the frequency band 302 of FIG. 3B), respectively. In some instances, the BS 105a and the BS 105b may be operated by different network operating entities. In some other instances, the BS 105a and the BS 105b may be operated by different network operating entities. In some instances, the BS 105a and the BS 105b may utilize the same RAT (e.g., NR-based technology or WiFi-based technology) for communications with the UE 115a and the UE 115b, respectively. In some other instances, the BS 105a and the BS 105b use different RATs for communications with the UE 115a and the UE 115b, respectively. For example, the BS 105a and the UE 115a may utilize an NR-based technology for communication, while the BS 105b and the UE 115b may utilize WiFi-based technology communication. In general, the BS 105a and the BS 105b may be operated by the same network operating entities or different network operating entities and may utilize the same RAT or different RATs for communications in the network 300. The BS 105a, the BS 105b, the UE 115a, and the UE 115b may share access to the channel using an FBE-based contention mode as shown in the FBE communication scheme 350.

Referring to FIG. 3B, the scheme 350 partitions the frequency band 302 into a plurality of frame periods 352 (shown as 352₍ₙ₋₁₎, 352₍ₙ₎, and 352₍ₙ₊₁₎). Each frame period 352 includes a contention or gap period 354 and a transmission period 356. The frame period 352 may have a resource structure as shown in the radio frame structure 200. In some instances, each frame period 352 may include one or more slots similar to the slots 202. In some instances, each frame period 352 may include one or more symbols similar to the symbols 206. The starting time and the duration of the frame periods 352 and the gap periods 354 are predetermined. Additionally, each frame period 352 may have the same duration. Similarly, each gap period 354 may have the same duration. Thus, the frame periods 352 may also be referred to as fixed frame periods (FFPs). In some other instances, the frame periods 352 may be referred to as COTs. In some aspects, a gap period 354 may have a minimum duration of maximum value between 5 percent (%) of the total time frame period 352 and 100 us according to some regulations.

A node (e.g., the BS 105a or the BS 105b) interested in using a frame period 352 for communication may contend for the channel during the corresponding gap period 354, for example, by performing an LBT to determine whether another node may have reserved the same frame period 352. If the LBT is successful, the node may transmit an indication of a reservation for the frame period 352 so that other nodes may refrain from using the same frame period 352. The LBT can be based on energy detection or signal detection. The reservation indication can be a predetermine sequence or waveform or any suitable signal. If the LBT is unsuccessful, the node may back off until the start of a next gap period 354, where the node may attempt another contention during the gap period 354.

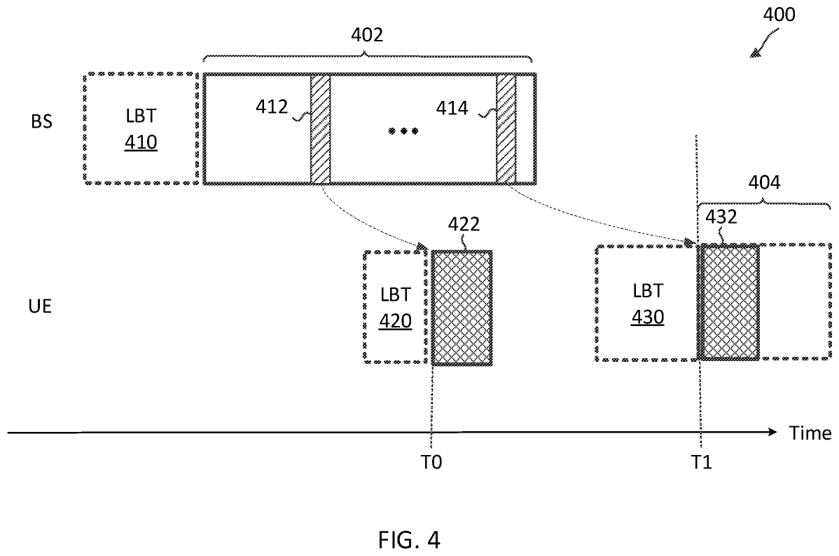

While FIG. 3B illustrates a gap period 354 located at the beginning of a frame period 352, in some instances, the gap period 354 can be located at the end of a frame period 352, where the gap period may be used for contention for a next frame period (see, e.g., FIG. 4).

In some aspects, each frame period 352 may have the same duration. In some aspects, the duration of a frame period 352 may be a factor of a reference duration. The reference duration may be twice the duration of a radio frame. For instance, for a 10 ms radio frame, a frame period 352 may have a duration of about 1 ms, 2 ms, 2.5 ms, 4 ms, 5 ms, 10 ms, or 20 ms. In an example, a frame period field may have a length of about 3 bits, where a value of 0 may indicate a duration of 1 ms, a value of 1 may indicate a duration of 2 ms, a value of 2 may indicate a duration of 2.5 ms, a value of 3 may indicate a duration of 4 ms, a value of 4 may indicate a duration of 5 ms, a value of 5 may indicate a duration of 10 ms, and a value of 6 may indicate a duration of 20 ms. When a radio frame has a duration of 10 ms, each radio frame may be aligned to the start of a frame period 352 for a frame period 352 duration of 1 ms, 2 ms, 2.5 ms, 4 ms, 5 ms, or 10 ms. For a frame period 352 duration of 20 ms, every other radio frame may align to the start of a frame period 352. In some other instances, the reference duration may be about 40 ms, 50 ms, 60 ms, 80 ms, 100 ms, or any suitable integer multiples of a radio frame duration.

In some aspects, the duration of a gap period 354 can be in units of symbols (e.g., the symbols 206). As discussed above, the gap period 354 may be configured to satisfy a certain regulation with a minimum of 5% of a total frame period. Thus, the gap period 354 may include a minimum integer number of symbols that is greater than a minimum portion (e.g., 5%) of the frame period 352. For example, the duration of the gap period 354 can be computed as shown below:

$${N}_{Symbols} = round ( \frac{0.05 \times {T}_{frame period}}{{T}_{Symbol}} ) , \qquad ( 1 )$$

where N_{symbols} represents the number of symbols in the gap period 354, T_{frame period} represents the duration of a frame period 352, and T_{symbol} represents the duration of a symbol. In some aspects, the minimum gap duration or the factor 5% may be configurable by the network. For instance, the factor may be 4%, 6%, or 7% or more. As an example, for a frame period 352 with a duration of about 4 ms and an SCS of about 30 kHz, the gap period 354 may include about 6 symbols. In some other instances, the gap period 354 may occupy a minimum percentage of the frame period 352 as specified by a wireless communication protocol. In some instances, the number of symbols in a gap period 354 may vary depending on the time location of the gap period 354 within a radio frame. For instance, in a certain configuration, the symbol time may be longer at every 0.5 ms.

In some aspects, the duration of a gap period 354 can be in units of slots (e.g., the slots 202). For example, the duration of the gap period 354 can be computed as shown below:

$${N}_{Slots} = round ( \frac{0.05 \times {T}_{frame period}}{{T}_{Slot}} ) , \qquad ( 2 )$$

where Nₛₗₒₜₛ represents the number of slots in the gap period 354, T_{frame period} represents the duration of a frame period 352, and Tₛₗₒₜ represents the duration of a slot.

In some aspects, a duration of the gap period 354 can be determined based on the duration of the frame period 352. As discussed, the gap period 354 may have a duration that is at least a certain factor (e.g., about 5%) of the duration of the frame period 352. Accordingly, the UE 115 may compute the duration of the gap period 354 using the equation (1) or (2) discussed above.

In the illustrated example of FIG. 3B, the BS 105a and the BS 105b may contend for the frame periods 352₍ₙ₋₁₎, 352₍ₙ₎, and 352₍ₙ₊₁₎ during corresponding gap periods 354. The BS 105a may win the contention for the frame period 352₍ₙ₋₁₎ and 352₍ₙ₊₁₎, while the BS 105b may win the contention for the frame period 352₍ₙ₎. After winning a contention, the BS 105a or the BS 105b may schedule DL communication(s) 360 and/or UL communication(s) 370 with the UE 115a or the UE 115b, respectively, within the corresponding non-gap duration or transmission period 356. The DL communication 360 may include DL control information (e.g., PDCCH control information) and/or DL data (e.g., PDSCH data). The UL communication 370 may include UL control information (e.g., PUCCH control information), PRACH signals, random access messages, periodic-sounding reference signals (p-SRSs), and/or UL data (e.g., PUSCH data). For instance, the BS 105a may transmit a DL scheduling grant (e.g., PDCCH scheduling DCI) or an UL scheduling grant (e.g., PDCCH scheduling DCI) for a DL communication 360 or an UL communication 370 with the UE 115a during the frame period 352₍ₙ₋₁₎. The UE 115a may monitor for scheduling grants from the BS 105a and transmit UL communication 370 to the BS 105a or receive DL communication 360 from the BS 105a according to the grants. In some aspects, the UE 115a may perform a category 2 (CAT2) LBT prior to transmitting the UL communication 370. A CAT2 LBT may refer to a one-shot LBT with no random backoff.

In some aspects, the BS 105a may transmit a PDCCH signal (shown as 360a1) at or near the beginning of the transmission period 356 to signal to the UE 115a that the BS 105a has won the contention for the frame period 352₍ₙ₋₁₎. In some instances, the PDCCH signal may include downlink control information (DCI). In some instances, the DCI includes a group common-PDCCH (GC-PDCCH) DCI signaling to a group of UEs served by the BS 105a that the BS 105a has won the contention for the frame period 352₍ₙ₋₁₎ so the UEs may monitor for PDCCH from the BS 105a. In some instances, the GC-PDCCH may include a slot format indication (SFI) indicating transmission directions assigned to symbols within the transmission period 356 of the frame period 352₍ₙ₋₁₎. The indication of the BS 105a winning access to the frame period 352₍ₙ₋₁₎ may generally be referred to as a COT indication.

In some aspects, the BS 105a may configure the UE 115a with configured grants or configured resources for configured UL transmissions. The configured grants or resources may be periodic. When a configured resource or grant is within the transmission period 356 of the frame period 352₍ₙ₋₁₎, the UE 115a may monitor for a COT indication from the BS 105a during the frame period 352₍ₙ₋₁₎. Upon detecting a COT indication from the BS 105a, the UE 115a may transmit using the configured grant resource in the frame period 352₍ₙ₋₁₎.

After a BS 105 successfully wins the contention for a frame period 352, the BS 105 can transmit a COT indication signal (e.g., a GC-PDCCH signal) in the frame period 352. When a served UE 115 detects the COT indication signal, the UE 115 may be aware that the serving BS 105 had acquired the frame period 352 and may share the frame period 352 for UL transmission. The UE 115 can perform an LBT (e.g., a CAT2 LBT) prior to transmitting in the BS-acquired frame period.

FIG. 4 is a timing diagram illustrating a communication scheme 400 according to some embodiments of the present disclosure. The scheme 400 may be employed by BSs such as the BSs 105 and UEs such as the UEs 115 in a network such as the network 100. In particular, a BS may employ the scheme 400 to schedule a UE for UL communications in a frequency spectrum (e.g., an unlicensed spectrum or a shared spectrum) shared by multiple network operating entities. In FIG. 4, the x-axis represent time in some arbitrary units.

In the scheme 400, a BS (e.g., BS 105 in FIG. 1) contends for a COT 402 by performing a CAT4 or CAT2 LBT 410 in a shared channel. Upon passing the CAT4 or CAT2 LBT 410, the COT 402 may begin. The BS may schedule the UE for UL and/or DL communications during the COT 402. The duration of the COT 402 may be based on an FBE configuration (e.g., as shown in FIGS. 3A and 3B). As shown, the BS transmits an UL scheduling grant 412 to schedule the UE for an UL communication at a time TO within the COT 402. The scheduling grant 412 may indicate resources (e.g., time-frequency resources) allocated for the UL communication and/or transmission parameters for the UL communication. Upon receiving the UL scheduling grant 412, the UE performs a CAT2 LBT 420 prior to the scheduled time TO. A CAT2 LBT refers to an LBT without a random backoff. A CAT2 LBT may also be referred to as a one-shot LBT. At time TO, upon passing the CAT2 LBT 420, the UE transmits an UL communication signal 422 based on the UL scheduling grant 412. The UL communication signal 422 can include UL data and/or UL control information. In an example, the UL data may be carried in a PUSCH the UL control information may carried in a PUCCH. The UL control information may include scheduling request, channel information (e.g., CSI reports), and/or hybrid automatic repeat request (HARD) acknowledgement/negative-acknowledgement (ACK/NACK) feedbacks.

Additionally, the BS transmits an UL scheduling grant 414 to schedule the UE for another UL communication at a time T1 outside of the COT 402. Upon receiving the UL scheduling grant 414, the UE performs a CAT4 or CAT2 LBT 430 prior to the scheduled time T0. At time T1, upon passing the CAT4 or CAT2 LBT 430, the UE transmits an UL communication signal 432 based on the UL scheduling grant 414. In other words, the UE gains a COT 404 outside of the BS's COT 402 for the transmission of the UL communication signal 432. The UL scheduling grant 414 and the UL communication signal 432 may be substantially similar to the scheduling grant 412 and the UL communication signal 432, respectively.

The UE may perform the CAT2 LBT 420 for the transmission of the UL communication signal 422 based on the schedule for the UL communication signal 422 being within the BS's COT 402. The UE may perform the CAT4 or CAT2 LBT 430 for the transmission of the UL communication signal 432 based on the schedule for the UL communication signal 432 being outside of the BS's COT 402.

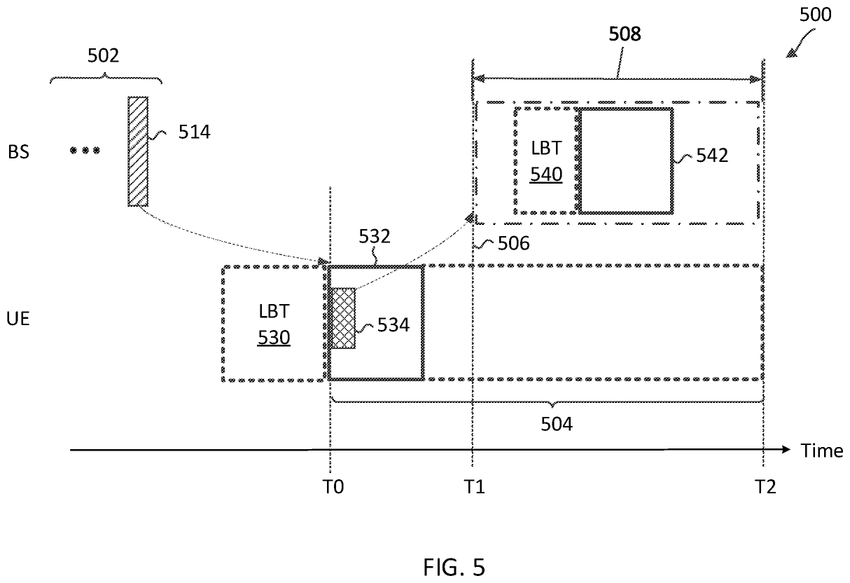

FIG. 5 is a timing diagram illustrating a scheme 500 for sharing a COT associated with a scheduled UL transmission according to some embodiments of the present disclosure. The scheme 500 may be employed by BSs such as the BSs 105 and UEs such as the UEs 115 in a network such as the network 100. In particular, a BS and a UE may employ the scheme 500 for UL-to-DL COT sharing in a frequency spectrum (e.g., an unlicensed spectrum or a shared spectrum) shared by multiple network operating entities. In FIG. 5, the x-axis represent time in some arbitrary units. In the scheme 500, a UE (e.g., UE 115 in FIG. 1) may initiate a COT based on an UL schedule received from a BS (e.g., BS 105 in FIG. 1) and share the COT with the BS for DL communication. The BS and the UE may use substantially similar LBT mechanisms as in the scheme 400 described in FIG. 4 to acquire a COT.

The UE performs a CAT4 or CAT2 LBT 530 prior to the scheduled time TO. Upon passing the LBT 530, the UE gains a COT 504 and transmits an UL communication signal 532 beginning at the scheduled time TO according to the UL scheduling grant 514. The COT 504 may include a duration longer than the transmission duration of the UL communication signal 532. For example, the COT 504 may end at time T2 based on a contention window length used for performing the CAT4 or CAT2 LBT 530. The duration of the COT 504 may be based on an FBE configuration (e.g., as shown in FIGS. 3A and 3B).

Accordingly, the UE may share the COT 504 with the BS for DL communication. In an embodiment, the UE includes COT sharing information 534 in the UL communication signal 532. The COT sharing information 534 may indicate that the BS is allowed to share the UE's COT 504 for communication. The COT sharing information 534 may indicate a sharable portion of the UE's COT 504 starting at a time 506 (e.g., at time T1) with a duration 508 as shown by the dashed-dotted box. In the context 5G or NR, the UL communication signal 532 may be a PUSCH signal and the COT sharing information 534 may be a PUCCH signal or an UL control information (UCI) message.

Upon receiving the COT sharing information 534, the BS performs a CAT2 LBT 540 and transmits a DL communication signal 542 during a period within the sharable duration 508. The DL communication signal 542 may include DL control information (e.g., DL scheduling grants) and/or DL data. In an embodiment, the BS may be allowed to use the UE's COT 504 for DL and/or UL communications with the UE and may not be allowed to use the UE's COT 504 for communication with another UE (e.g., UE 115 in FIG. 1). In an embodiment, the BS may be allowed to use the UE's COT 504 for DL communication with the UE (that initiated the COT 504) or another UE (e.g., UE 115 in FIG. 1) after communicating with the UE. In some aspects, the BS may transmit in a remaining portion (a shared portion) of the UE's COT 504 without receiving the COT sharing information 534.

In some instances, other UEs having different configurations may be present in a network. In some aspects, the other UEs may have configurations that do not provide for UE-initiated COT sharing. Further, the UE shown in FIG. 5 may be configured to recognize, in DL control information, a DL transmission identifier that indicates whether a DL communication is transmitted in a BS-acquired COT, or a shared portion of a UE-acquired COT. However, other UEs in the network may not be configured to recognize this DL transmission identifier. For example, other UEs have different UE-type configurations may falsely assume that a DL communication transmitted by the BS in FBE mode is transmitted in a BS-acquired COT. Based on this assumption, the UEs may attempt to share a portion of the COT, which is not intended to share the COT. This may result in unnecessary processing overhead, in some aspects. Accordingly, the present disclosure provides for schemes and mechanisms for selective DL transmissions and/or selective monitoring or processing in semi-static channel access communication schemes in which a variety of UE-type configurations are being used. In particular, the schemes described herein allow for a BS to transmit a DL communication in a shared portion of a UE-acquired COT, such that one or more UEs having a different UE-type configuration do not detect and/or decode the DL communication.

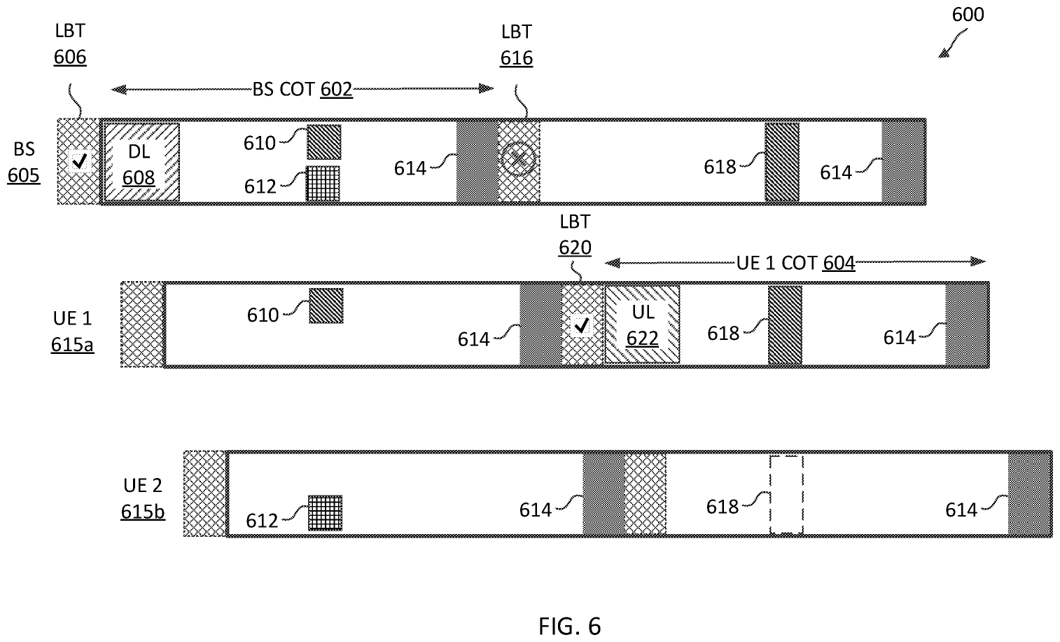

FIG. 6 is a timing diagram illustrating a scheme 600 for transmitting and detecting DL transmissions using semi-static channel access according to some embodiments of the present disclosure. The scheme 600 is employed by a BS 605, a first UE (UE 1) 615a, and a second UE (UE 2) 615b. The BS 605 may be one the BSs 105 of the network 100. The first UE 615a and the second UE 615b may be UEs 115 of the network 100. In particular, the BS 605 and the UEs 615a, 615b may employ the scheme 600 for UL-to-DL COT sharing in a frequency spectrum (e.g., an unlicensed spectrum or a shared spectrum) shared by multiple network operating entities. In FIG. 6, the x-axis represent time in some arbitrary units. In the scheme 600, the BS 605 initiates a first COT 602, and the first UE 615a initiates a second COT 604 and shares a portion of the second COT 604 with the BS 605. For the purposes of the present disclosure, a BS-acquired COT and a UE-acquired COT may be referred to as different COT types, where a BS-acquired COT is, for example, a first COT type, and a UE-acquired COT is a second COT type. The BS 605 and the UE 615a may use substantially similar LBT mechanisms as in the scheme 400 described in FIG. 4 to acquire and/or share the COTs 602, 604.

The BS 605 performs a LBT 606, such as a CAT2 LBT, which results in a pass. As explained above, the LBT 606 may include obtaining signal energy measurements over a time period in the shared frequency band and comparing the signal measurements to a threshold. When the CAT2 LBT 606 passes, the BS 605 acquires or wins the first COT 602. The first COT 602 may be associated with a first fixed frame period (FFP). During the first COT 602, the BS 605 transmits a DL communication 608, a first control signal 610, and a second control signal 612. In some aspects, the first and second control signals 610, 612 may include downlink control information (DCI). In some aspects, the first and second control signals 610, 612 may be transmitted in respective PDCCH resources, such as group common PDCCHs (GC-PDCCHs). As shown, both downlink control signals 610, 612 are transmitted in the same COT 602. In some aspects, the DL control signals 610, 612 may be transmitted in a same time period, or in overlapping time periods. For example, the DL control signals 610, 612 may be transmitted in a time period corresponding to a same monitoring occasion of at least one of the UEs 615a, 615b. In other aspects, the DL control signals 610, 612 may be transmitted in non-overlapping time periods. Following the transmission of the DL control signals 610, 612, the BS 605 ceases communications during an idle period or gap period 614. In this regard, the configurations of the BS 605 and the UEs 615a, 615b may include gap periods 614 at the end of each FFP.

The BS 605 prepares the DL control signals 610, 612 with different scrambling identities (IDs), where each scrambling ID is associated with a different one of the UEs 615a, 615b. Each UE 615a, 615b may be configured to monitor for downlink control signals using a respective one of the scrambling IDs. Accordingly, the first UE 615a can detect the first DL control signal 610, and the second UE 615b can detect the second DL control signal 612. In some aspects, the scrambling ID may be associated with a CORESET configuration of a UE 615. For example, the scrambling IDs may be de-modulation reference signal (DMRS) scrambling IDs. Accordingly, the first UE 615a, using a first scrambling ID, monitors for and detects the first DL control signal 610, but not the second DL control signal 612. For instance, the first DL control signal 610 may include a DMRS that is based on the first scrambling ID and DCI. The first UE 615a may detect the presence of the first DL control signal 610 based on a successful detection of the DMRS in the first DL control signal 610. Similarly, the second UE 615b, using a second scrambling ID different from the first scrambling ID, monitors for and detects the second DL control signal 612, but not the first DL control signal 610. For instance, the second DL control signal 612 may include a DMRS that is based on the second scrambling ID and DCI. The second UE 615b may detect the presence of the second DL control signal 612 based on a successful detection of the DMRS in the second DL control signal 612. The BS 605 may select or determine the scrambling ID for a DL communication based on the configurations of the UEs 615a, 615b. The configurations of the UEs 615a, 615b may be UE-type configurations, which refers to the configured parameters of each of a plurality of types of UEs. For example, in FIG. 6, the first UE 615a has a first UE-type configuration, and the second UE has a second UE-type configuration. In some aspects, the first UE-type configuration may enable UE-initiated COT acquisition and sharing, and the second UE-type configuration may not enable UE-initiated COT acquisition and/or sharing. Further, in some aspects, the first UE-type configuration may configure a UE to detect or recognize a DL transmission identifier that indicates whether a DL communication is transmitted in a shared portion of a UE-initiated COT, or in a BS-initiated COT. Thus, in some aspects, the first UE-type configuration may be referred to as an enhanced UE-type configuration. In the scheme 600, the BS 605 can transmit downlink control signals (e.g., GC-PDCCH) based on the UE-type configurations of each UE 615a, 615b. In this way, the BS 605 can determine or control which of the UEs 615a, 615b detect DL communications, which can help avoid or resolve the issues mentioned above.

The BS 605 performs a second LBT 616, which may also be a CAT2 LBT, associated with a second BS FFP, which results in a fail. A failed LBT may be detected or determined based on signal energy measurements in the channel exceeding an energy detection threshold. The energy detection threshold may be configured in the BS, and may be associated with a type of LBT (e.g., CAT2, CAT4). The first UE 615a also performs a CAT2 LBT 620 associated with a second UE FFP, which results in a pass, and the first UE 615a wins the COT 604. During the COT 604, the first UE 615a transmits an UL communication 622 to the BS 605. The UL communication 622 may include COT sharing information, which indicates to the BS 605 that the BS 605 can use resources in the COT 604 for a DL communication 618. In some instances, the UL communication 622 may not include or indicate COT sharing information. The BS 605 transmits the DL communication 618 in the COT based on the UE-type configuration of the first UE 615a (i.e. the first UE-type configuration). In one example, the first UE-type configuration may include parameters and mechanisms for acquiring the COT 604 in a semi-static channel access mode, and sharing a portion of the COT 604 with the BS 605. The second UE-type configuration of the second UE 615b may not include parameters and/or mechanisms for sharing a portion of the COT with the BS 605 in a semi-static channel access mode. For example, the second UE 615b having the second UE-type configuration may assume that any detected DL communications during a COT are transmitted in a BS-acquired COT. Thus, if the second UE 615b detected the DL communication 618, the second UE 615b may assume that the DL communication 618 is transmitted in a BS-acquired COT, and may attempt to share the COT 604 by transmitting an UL communication back to the BS 605.

In the scheme 600, the DL communication 618, which may include a DL control signal, is prepared and transmitted based on the first scrambling ID, which is associated with the first UE-type configuration. The DL communication 618 may include a message field including an indication that the DL communication 618 is transmitted in a UE-acquire COT. When another UE of the first UE-type configuration detected the DL communication 618, the other UE may be aware of the message field, and thus may not share the COT 604 based on the message field. While a UE (e.g., the second UE 615b) of the second UE-type configuration may not be aware of the message field in the DL communication 618, the UE of the second UE-type configuration may not detect the DL communication 618. Accordingly, this prevents UEs having the second UE-type configuration from using processing resources in attempting to share the UE-acquired COT 604.

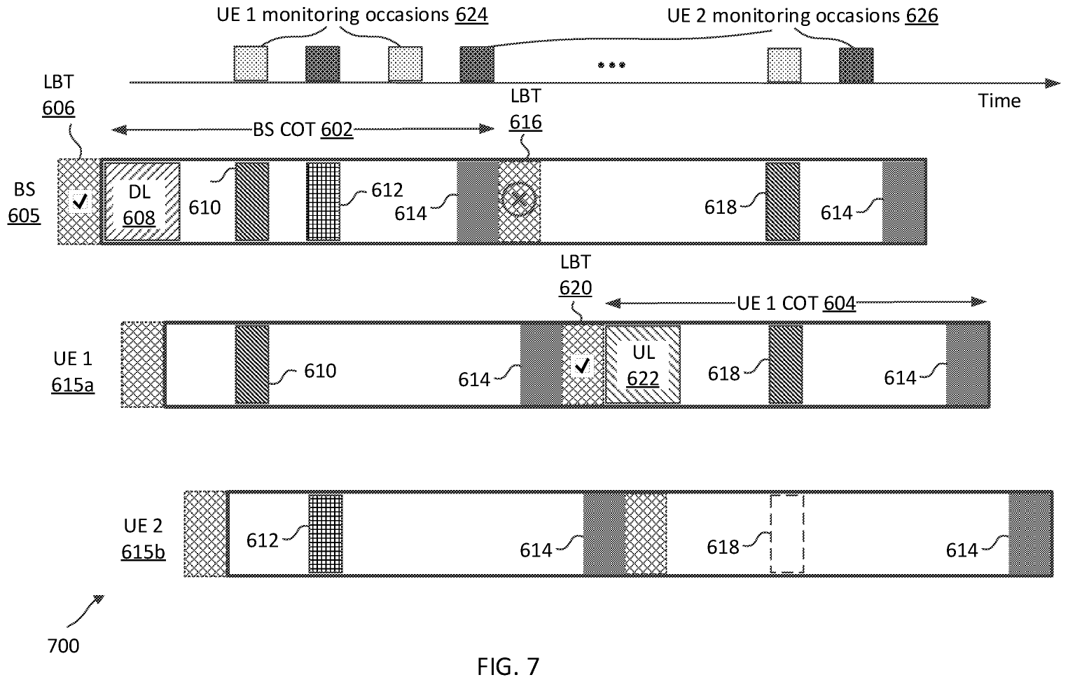

FIG. 7 is a timing diagram illustrating a scheme 700 for indicating and detecting DL transmissions using semi-static channel access according to some embodiments of the present disclosure. Similar to the scheme 600 shown in FIG. 6, the scheme 700 is employed in a shared frequency band (e.g., in NR-U) by the BS 605, the first UE 615a, and the second UE 615b. The BS 605 may be one the BSs 105 of the network 100. The first UE 615a and the second UE 615b may be UEs 115 of the network 100. The x-axis represent time in some arbitrary units. In the scheme 700, the BS 605 initiates a first COT 602, and the first UE 615a initiates a second COT 604, and shares a portion of the second COT 604 with the BS 605. The BS 605 and the first UE 615a may use substantially similar LBT mechanisms as in the scheme 400 described in FIG. 4 to acquire and/or share the COTs 602, 604. In the scheme 700, the BS 605 transmits DL control signals 610, 612 in different UE monitoring occasions 624, 626 (e.g., PDCCH monitoring occasions) respectively associated with the UEs 615a, 615b. The BS 605 may configure UEs of the first UE-type configuration and UEs of the second UE-type configuration with different PDCCH monitoring occasions to avoid DL transmission detection in a UE-acquired COT by UEs of the second UE-type configuration.

The BS 605 performs a CAT2 LBT 606, which results in a pass. As explained above, the LBT 606 may include obtaining signal energy measurements over a time period in the shared frequency band and comparing the signal measurements to a threshold. When the CAT2 LBT 606 passes, the BS 605 acquires or wins the first COT 602, which may be associated with a first BS FFP. During the first COT 602, the BS 605 transmits a DL communication 608, a first control signal 610, and a second control signal 612. In some aspects, the first and second control signals 610, 612 may include downlink control information (DCI), and may be transmitted in respective PDCCH resources, such as GC-PDCCHs. As shown, both downlink control signals 610, 612 are transmitted in the first COT 602, but in different monitoring occasions that correspond, respectively, to the UEs 615a, 615b. In particular, the first DL control signal 610 is transmitted in one of the first UE monitoring occasions 624, and the second DL control signal 612 is transmitted in one of the second UE monitoring occasions 626. The first UE 615a is configured to monitor for DL control information (e.g., in a GC-PDCCH) in the first UE monitoring occasions 624, and the second UE 615b is configured to monitor for DL control information in the second UE monitoring occasions 626. The BS 605 may prepare and transmit the DL control signals 610, 612 based on a same scrambling ID, or different scrambling IDs. The first UE 615a receives and decodes the first DL control signal 610, and the second UE 615b receives and decodes the second DL control signal 612 and not the first DL control signal 610. In some aspects, the UE-type configuration associated with each UE may indicate the monitoring occasions for each UE. Accordingly, the BS 605 may determine or select which of the UEs 615a, 615b to receive the DL control signal by selecting a UE monitoring occasion for transmitting the DL control signal.

The BS 605 performs a second CAT2 LBT 616 associated with a second BS FFP, which results in a fail. The first UE 615a also performs a CAT2 LBT 620 associated with a second UE FFP, which results in a pass, and the first UE 615a wins the COT 604. During the COT 604, the first UE 615a transmits an UL communication 622 to the BS 605. The UL communication 622 may include COT sharing information, which indicates to the BS 605 that the BS 605 can use resources in the COT 604 for a DL communication 618. Because the DL communication 618 will be transmitted in a shared portion of a UE-acquired COT 640, the BS 605 transmits the DL communication 618 in one of the first UE monitoring occasions 624 based on the UE-type configuration of the first UE 615a (i.e. the first UE-type configuration). Because the second UE-type configuration of the second UE 615b indicates the second UE monitoring occasions 626, the second UE 615b does not detect or decode the DL communication 618. Accordingly, the BS 605 can share the UE-acquired COT 604 without triggering the second UE 615b to attempt to share the COT 604 based on a false assumption that the COT 604 is a BS-acquired COT 604.

In the schemes 600 and 700 described above, to transmit DL control information and/or other DL communications that can be detected/decoded by both UEs 615a, 615b having different UE-type configurations, the BS 605 transmits two different DL control signals in a single COT, and each UE 615a, 615b may only detect one of the DL control signals 610, 612 based on the different scrambling IDs and/or the different monitoring occasions the BS 605 uses to prepare and transmit the DL control signals. Stated different, each UE 615a, 615b may monitor for only one of the DL control signals 610, 612 in the schemes 600, 700. In some instances, it may be desirable to provide schemes and mechanisms in which the BS 605 may transmit one DL control signal in a BS-acquired COT that can be detected by both UEs 615a, 615b, and a different DL control signal in a shared portion of a UE-acquired COT that can be detected by the first UE 615a (of the first UE-type configuration) and not the second UE 615b (of the second UE-type configuration).

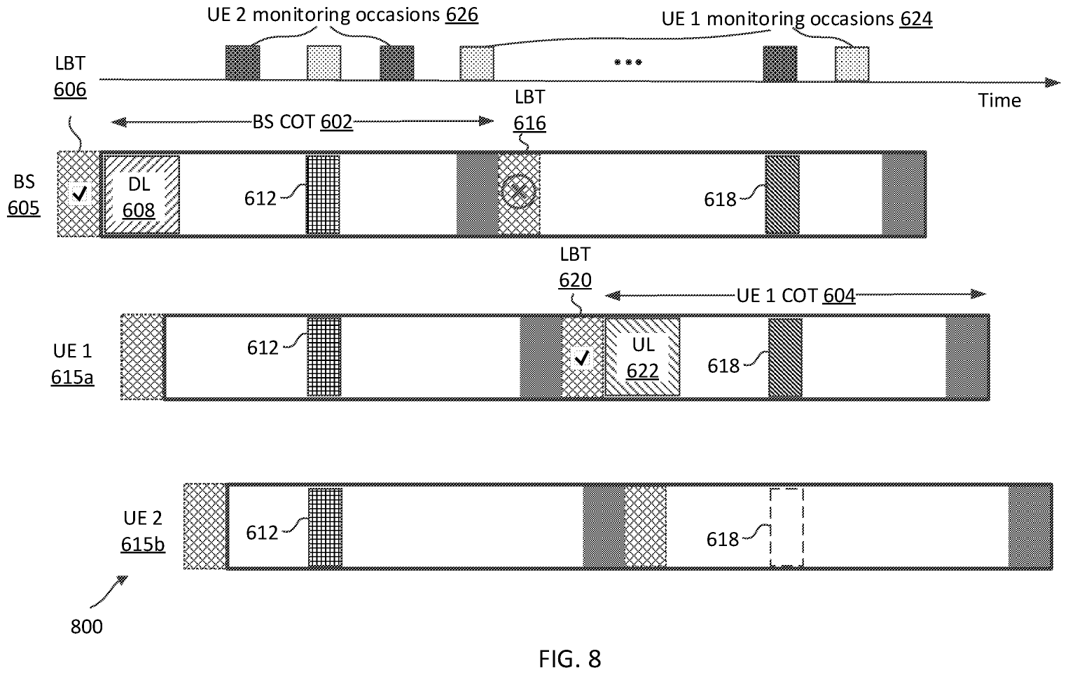

FIG. 8 is a timing diagram illustrating a scheme 800 for transmitting and detecting DL transmissions using semi-static channel access according to some embodiments of the present disclosure. Similar to the schemes 600-700 shown in FIGS. 6-7, the scheme 800 is employed in a shared frequency band (e.g., in NR-U) by the BS 605, the first UE 615a, and the second UE 615b. The BS 605 may be one the BSs 105 of the network 100. The first UE 615a and the second UE 615b may be UEs 115 of the network 100. The x-axis represent time in some arbitrary units. In the scheme 800, the BS 605 initiates a first COT 602, and the first UE 615a initiates a second COT 604 and shares a portion of the second COT 604 with the BS 605. The BS 605 and the first UE 615a may use substantially similar LBT mechanisms as in the scheme 400 described in FIG. 4 to acquire and/or share the COTs 602, 604. In the scheme 800, the BS 605 transmits a DL control signal 612 which is detectable by both UEs 615a, 615b, and transmits a DL communication (e.g., second DL control signal) 618 that is detectable by only the first UE 615a having the first UE-type configuration, and not the second UE 615b having the second UE-type configuration.

The BS 605 performs a CAT2 LBT 606, which results in a pass, and the BS 605 acquires or wins the first COT 602. During the COT 602, the BS 605 transmits a DL communication 608 and a DL control signal 612. The BS 605 transmits the DL control signal 612 in one of a plurality of first monitoring occasions 624. Both the first UE 615a and the second UE 615b are configured to monitor for DL control information in the first monitoring occasions 624. Stated differently, both the first UE-type configuration and the second UE-type configuration configure the UEs 615a, 615b to monitor in the first UE monitoring occasions 624. Accordingly, both the first UE 615a and the second UE 615b can detect and/or decode the DL control signal 612. The first UE 615a is also configured to monitor for DL control information in the second UE monitoring occasions 626. The first UE 615a monitors for DL control signals in both groups of monitoring occasions 624, 626. In some aspects, the control signal 612 may include DCI, and may be transmitted in a PDCCH resource, such as a GC-PDCCH. Thus, the BS 605 may transmit a DL control signal such that it can be detected or decoded by both UEs 615a, 615b, or by only the first UE 615a, as explained further below.

The BS 605 performs a second CAT2 LBT 616 associated with a second BS FFP, which results in a fail. The first UE 615a also performs a CAT2 LBT 620 associated with a second UE FFP, which results in a pass, and the first UE 615a wins the COT 604. During the COT 604, the first UE 615a transmits an UL communication 622 to the BS 605. The UL communication 622 may include COT sharing information, which indicates to the BS 605 that the BS 605 can use resources in the COT 604 for a DL communication 618. The BS 605 transmits the DL communication 618 in one of the second UE monitoring occasions 624 based on the configuration of the first UE 615a (i.e. the first UE-type configuration). Because the first UE-type configuration of the first UE 615a configures the first UE 615a to monitor for DL control signals in both the first UE monitoring occasions 624 and the second UE monitoring occasions 626, the first UE 615a detects the DL communication 618. Because the second UE-type configuration of the second UE 615b does not configure the second UE 615b to monitor in the second UE monitoring occasions 626, the second UE 615b does not detect or decode the DL communication 618.

In some embodiments, the BS 605 may transmit the DL control information intended for both UEs 615a, 615b using a first scrambling ID (e.g., DMRS scrambling ID), and may transmit DL control information or DL communications intended for only the first UE 615a (or UEs associated with the first UE-type configuration) based on a second scrambling ID different form the first scrambling ID. In this regard, if the BS 605 uses different scrambling IDs to transmit DL control information, the BS 605 may transmit the DL control signals intended for the first UE-type configuration and/or the second UE-type configuration using the same UE monitoring occasions.

Accordingly, the scheme 800 allows for the BS 605 to share the UE-acquired COT 604 without triggering the second UE 615b to attempt to share the COT 604 based on a false assumption that the COT 604 is a BS-acquired COT 604. Further, the BS 605 can selectively transmit DL control signals to UEs associated with either the first or second UE-type configuration, or to UEs associated with the first UE-type configuration only, without sending multiple DL control signals in a single COT. It will be understood that the scheme 800 includes the first UE 615a doing two decodings, which may include the first UE 615a performing two decodings in a single monitoring occasion, or monitoring and decoding in multiple monitoring occasions in the COT. In some aspects, it may also be desirable to enable a UE 615 to perform a single decoding to detect DL control signals and/or DL communications associated with two or more UE-type configurations. For example, the BS 605 may configure UEs of the first UE-type configuration with a CORESET configuration including the first scrambling ID and the second scrambling ID. The first UE 615a having the first UE-type configuration performs two blind decodings for each PDCCH candidate or monitoring occasion, instead of one blind decoding. While this may allow the BS 605 to transmit a single GC-PDCCH in a UE-acquired COT or a BS-acquired COT, the additional blind decoding can be costly in processing for UEs having the first UE-type configuration.

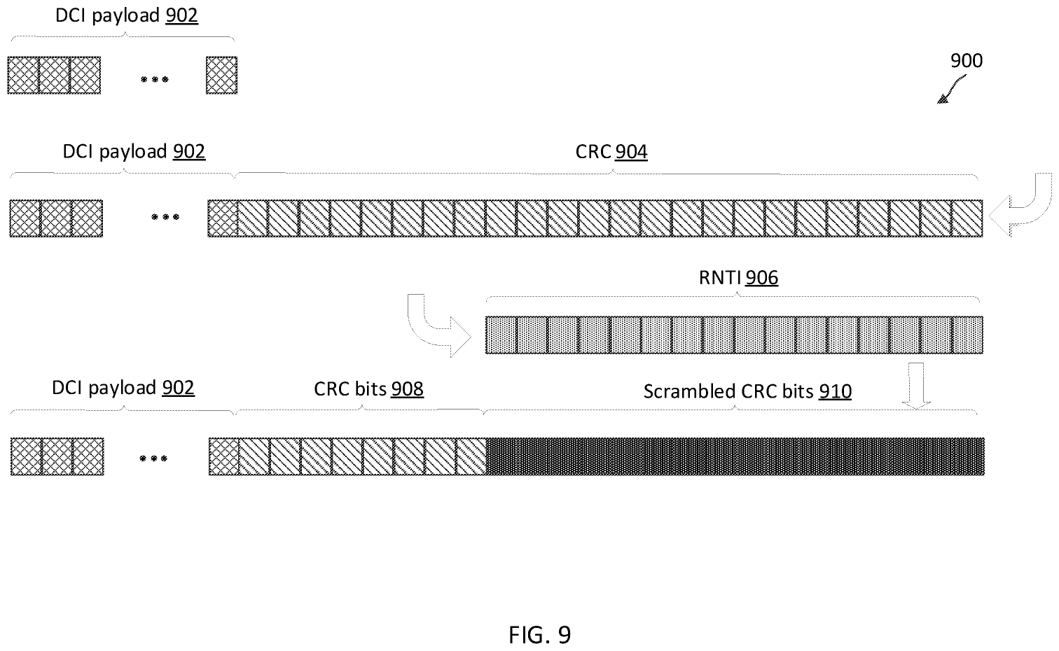

FIGS. 9-12 illustrate various schemes for encoding and decoding DL control signals for semi-static channel access (FBE mode) with UE-initiated COT sharing enabled. The schemes illustrated in FIGS. 9-12 may be performed by a BS, a first UE associated with a first UE-type configuration, and a second UE associated with a second UE-type configuration. The BS may be one of the BSs 105, 605 described above, and the first and second UEs may be the UEs 115, 615 described above. In the schemes of FIGS. 9-12, the first UE-type configuration may be referred to as an enhanced configuration. For example, the first UE-type configuration may include parameters and mechanisms that configure the first UE to acquire and share COTs, and the second UE-type configuration may not include one or more of those parameters. For example, in some aspects, a UE using the second UE-type configuration may assume, when a DL control signal is detected in an FFP, that the DL control signal was transmitted in a BS-acquired COT, even if the DL control signal is transmitted in a shared portion of a UE-acquired or initiated COT. The schemes described below may allow the BS to transmit DL control signals in a shared portion of a UE-acquired COT such that the UE associated with the second UE-type configuration does not detect the DL control signals. Further, the schemes described below may allow the first UE (e.g., 615a) to detect DL control signals associated with either the first UE-type configuration or the second UE-type configuration based on a single decoding.

FIG. 9 illustrates a scheme 900 for transmitting and detecting DL transmissions using semi-static channel access according to some embodiments of the present disclosure. Similar to the schemes 600-800 shown in FIGS. 6-8, the scheme 900 is employed in a shared frequency band (e.g., in NR-U) by a BS, a first UE, and a second UE. The BS may be one the BSs 105 of the network 100. The first UE and the second UE may be UEs 115 of the network 100. In the scheme 900, the BS attaches a cyclic redundancy check (CRC) 904 to a payload 902, which includes downlink control information (DCI). The BS scrambles at least a portion of the CRC 904 based on a radio network temporary identifier (RNTI) 906. The RNTI 906 may be a GC-PDCCH-specific RNTI. The BS may determine or select the RNTI 906 to scramble the CRC 904 based on the UE-type configuration or configurations of the UEs which the payload (e.g., DCI 902), is intended for. Although the scheme 900 is illustrated with respect to the BS decoding, scrambling, and preparing the DCI 902 for transmission, it will be understood that the UEs may descramble and/or decode a DL transmission using a similar scheme in a reverse order. For example, a UE may be configured to compute a CRC for a decoded DCI payload, descramble the CRC bits using the RNTI 906, and check the descrambled CRC against the computed CRC.

In the scheme 900, the BS provides a DL control channel payload, which may include DCI 902. The DCI 902 may be intended for transmission to one or more UEs over a PDCCH, such as a GC-PDCCH. The BS computes and attaches a 24-bit CRC to the DCI 902. The BS may compute or calculate the CRC based on a CRC polynomial. The BS modifies or scrambles at least a portion of the CRC 904 using a RNTI 906. In some aspects, the RNTI 906 may be a slot format indicator RNTI (SFI-RNTI), a cell-radio RNTI (C-RNTI), a system information RNTI (SI-RNTI), or any other suitable type of RNTI. The DCI 902 may be a DCI format 2_0, for example, or any other suitable type of DCI. As illustrated, the BS scrambles the last 16 bits of the CRC 904 with the RNTI 906, and the first 8 bits of the CRC 904 remain unscrambled or unmodified by the RNTI 906. In one example, the BS may scramble the last 16 bits of the CRC to generate scrambled bits cₖ based on the formula:

cₖ=(bₖ+x_{rnti,k})mod 2, (3)

where bₖ is an appended CRC value for bit k, and x_{rnti,k} is the RNTI value corresponding to bit k, mod represents a modulo operation, and where the bits k include the last 16 bits of the CRC and the corresponding bits of the RNTI 906.

The BS may select or determine the RNTI based on the UE-type configuration of the UEs that are the intended recipients of the DCI 902. For example, as explained above with respect to the schemes 600-800, it may be desirable for the BS to transmit the DCI 902 such that a first UE or group of UEs having a first UE-type configuration can detect the DCI 902, and such that a second UE or group of UEs having a second UE-type configuration cannot detect and/or decode the DCI 902. For example, the BS may transmit the DCI 902 in a shared portion of a UE-initiated COT. In order to avoid causing a UE with the second UE-type configuration from erroneously determining that the BS payload is being transmitted in a BS-acquired COT, the BS selects the RNTI 906 based on the first UE-type configuration such that UEs having the first UE-type configuration, and not UEs having the second UE-type configuration, can decode and/or detect the DCI 902.

As mentioned above, a UE having the first UE-type configuration associated with the RNTI 906 can descramble the encoded and scrambled DL control signal transmitted by the BS based on the RNTI 906. A UE having a second UE-type configuration (for example, for which UE-initiated COT sharing is not enabled or supported) may not be configured with the RNTI 906, and thus may fail to descramble and/or decode the DL control signal.

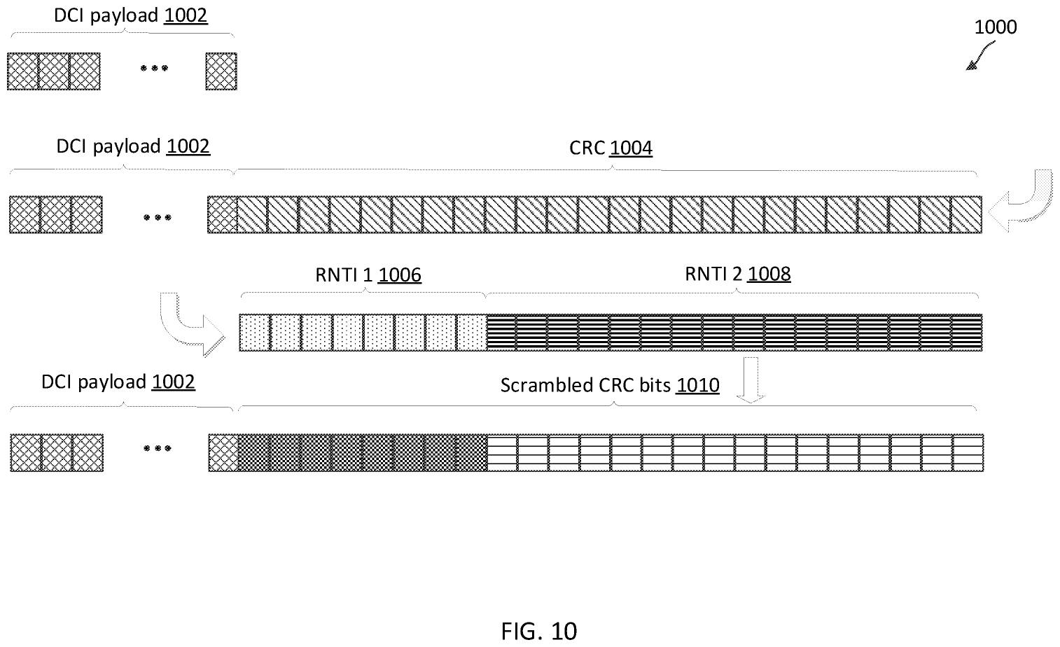

Another example of DL transmission and detection in semi-static communication scenarios with multiple UE-type configurations is shown in FIG. 10. In this regard, FIG. 10 illustrates a scheme 1000 for indicating and detecting DL transmissions for different UE-type configurations using two RNTIs, according to some embodiments of the present disclosure. Similar to the schemes 600-900 shown in FIGS. 6-9, the scheme 1000 may be employed in a shared frequency band (e.g., in NR-U) by a BS, a first UE, and a second UE. The BS may be one the BSs 105 of the network 100. The first UE and the second UE may be UEs 115 of the network 100.

In the scheme 1000, the BS attaches a cyclic redundancy check 1004 to a payload 1002, which includes DCI, and scrambles a portion of the CRC 1004 based on a first RNTI 1006 and a second RNTI 1008. In the scheme 1000, the first RNTI 1006 has a length of 16 bits, and the second RNTI 1008 has a length of 8 bits. In some aspects, the first RNTI 1006 may be associated with both a first UE-type configuration and a second UE-type configuration. Stated differently, UEs having either the first UE-type configuration or the second UE-type configuration may be configured to descramble a DL control signal using the first RNTI 1006. The BS uses the first RNTI 1006, which is common to both UE-type configurations, to scramble the last 16 bits of the CRC 1004. Further, the BS uses the second shorter RNTI 1008, which has a length of 8 bits in the scheme 1000, to scramble the first 8 bits of the CRC 1004. The second RNTI 1008 may be configured for the first UE-type configuration, but not configured for the second UE-type configuration. Accordingly, the first UE having the first UE-type configuration, which indicates both the first RNTI 1006 and the second RNTI 1008, will be able to successfully descramble the CRC 1004 and passes the CRC check. However, since the second UE-type configuration is configured with the first RNTI 1006, but not the second RNTI 1008, the second UE may descramble the CRC 1004 incorrectly, and thus may fail the CRC check.

The BS may determine or select the RNTI 1006 and/or the RNTI 1008 to scramble the CRC 1004 based on the UE-type configuration or configurations of the UEs which the payload (e.g., DCI 902), is intended for. Although the scheme 1000 is illustrated with respect to the BS decoding, scrambling, and preparing the DCI 1002 for transmission, it will be understood that the UEs may descramble and/or decode a DL transmission using a similar scheme in a reverse order. For example, a UE may be configured to compute a CRC for a decoded DCI payload, descramble the CRC bits using the RNTI 1006 and the RNTI 1008, and check the descrambled CRC against the computed CRC.

In one example, the BS may scramble the last 16 bits of the CRC to generate scrambled bits cₖ based on the formula:

cₖ=(bₖ+x_{rnti,k})mod 2, (4)

where bₖ is an appended CRC value for bit k, and x_{rnti,k} is the first RNTI value corresponding to bit k. Further, the BS may scramble the first 8 bits of the CRC to generate c 1 based on the formula:

cⱼ=(bⱼ+y_{rnti,j})mod 2, (5)

where bⱼ is an appended CRC value for bit j, and y_{rnti,j} is the second RNTI value corresponding to bit j, where the bits j correspond to the first 8 bits of the CRC and combined RNTIs, and the bits k correspond to the last 16 bits of the CRC and combined RNTIs. Accordingly, in some aspects, k may vary from 8 to 23, and j may vary from 0-7.

The BS determines whether to scramble the DCI 1002 with only the second RNTI 1008 or both the first RNTI 1006 and the second RNTI 1008 based on the UE-type configuration of the UEs that are the intended recipients of the DCI 1002. For example, as explained above with respect to the schemes 600-900, it may be desirable for the BS to transmit the DCI 1002 such that a first UE or group of UEs having a first UE-type configuration can detect the DCI 1002, and such that a second UE or group of UEs having a second UE-type configuration cannot detect and/or decode the DCI 1002. That is, the BS may determine whether to scramble a CRC for DCI 1002 with the additional RNTI 1006 based on whether the DCI 1002 is to be transmitted in a BS-acquired COT or a UE-acquired COT. For example, the BS may transmit the DCI 1002 in a shared portion of a UE-initiated COT. In order to avoid causing a UE with the second UE-type configuration from erroneously determining that the BS payload is being transmitted in a BS-acquired COT, the BS determines to scramble the CRC 1004 with both the first RNTI 1006 and the second RNTI 1008 based on the first UE-type configuration such that UEs having the first UE-type configuration, and not UEs having the second UE-type configuration, can decode and/or detect the DCI 1002. In some aspects, the first UE may first descramble the DL control signal using the second RNTI 1008 only. If the descrambling is successful, the first UE may perform an additional descrambling using both the first RNTI 1006 and the second RNTI 1008. If the further descrambling results in a pass, the DCI 1002 is intended for UEs having the first UE-type configuration. If the further descrambling does not pass, the DCI 1002 is intended for UEs having the second UE-type configuration. In another example, if the BS is preparing a DCI for transmission to UEs having either the first UE-type configuration or the second UE-type configuration, the BS may scramble the CRC 1004 with the second RNTI 1008 only.

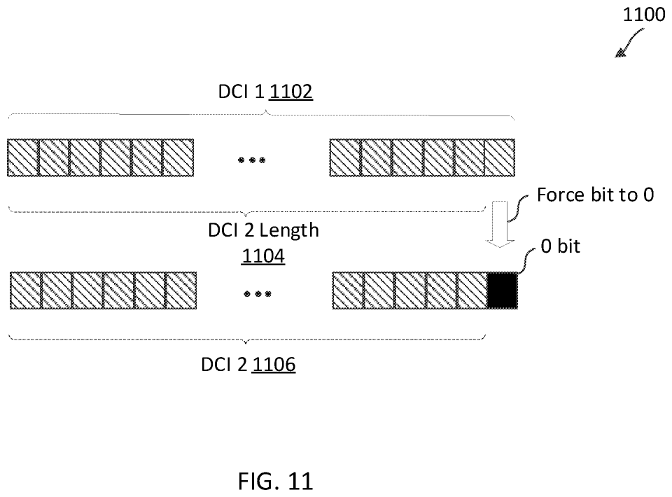

FIG. 11 illustrates a scheme 1100 for indicating and detecting DL transmissions using semi-static channel access according to some aspects of the present disclosure. Similar to the schemes 600-1000 shown in FIGS. 6-10, the scheme 1100 is employed in a shared frequency band (e.g., in NR-U) by a BS, a first UE, and a second UE. The BS may be one the BSs 105 of the network 100. The first UE and the second UE may be UEs 115 of the network 100. In the scheme 1100, the BS determines a length (bit length) of a DCI 1002 for transmission to a UE based on the UE-type configuration of the receiving UE(s). In this regard, FIG. 11 shows the DCI 1 1102 having a length of X bits, where a DCI 2, which may be associated with a second UE-type configuration, has a length 1104 of X-1 bits. In some aspects, the UE(s) having the first UE-type configuration can decode the DCI 1 1102, and the UE(s) having the second UE-type configuration cannot decode the DCI 1 1102, due to the longer length of the DCI 1 1102. In this regard, the second UE-type configuration may indicate parameters for decoding DCIs having a length of X-1 bits, for example, but not DCIs having a length of X bits.

Based on the properties of polar code, where two polar codes (K₁, N) and (K₂, N) with the same rate-matching scheme, where K₁ and K₂ represent the number of information bits and N represents a codeword length, if K₁>K₂, the set of information bits K₂ is a subset of the information bits K₁. The K₂ information bits can be obtained by setting the different information bits between K₁ and K₂ to zeroes. The BS may encode DCI using polar codes. In this way, a UE having the first UE-type configuration may detect the DCI 1 1102, as well as DCIs having a length of N−1. Further, the UEs having the first UE-type configuration may be able to obtain or decode the DCI 1102 using a single decoding operation (a single blind decoding or detection per PDCCH candidate), whether the DCI has a length of N or N−1. In some aspects, the first UE-type configuration may configure the UE to decode all N bits of the DCI 1 1102, and then force one or more bits of the DCI 1 1102 to zero, and the payload DCI 2 1106 associated with the first N−1 bits can be obtained. Accordingly, UEs having the first UE-type configuration may decode DCIs having lengths of either N or N−1, while the UEs having the second UE-type configuration may decode DCIs having lengths of N−1 only.

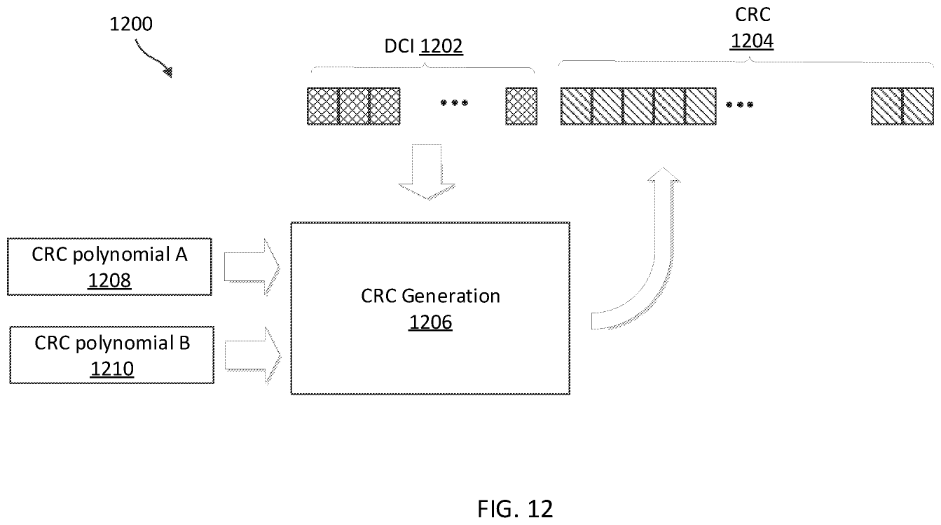

FIG. 12 illustrates a scheme 1200 for indicating and detecting DL transmissions using semi-static channel access according to some aspects of the present disclosure. Similar to the schemes 600-1100 shown in FIGS. 6-11, the scheme 1200 is employed in a shared frequency band (e.g., in NR-U) by a BS, a first UE, and a second UE. The BS may be one the BSs 105 of the network 100. The first UE and the second UE may be UEs 115 of the network 100. In the scheme 1200, the BS generates and appends a CRC 1204 to DCI 1202 by selecting a CRC polynomial associated with a UE-type configuration of the intended UE recipient of the DCI 1202.

In this regard, FIG. 12 shows a CRC 1204 being appended to a DCI 1202, where the CRC 1204 is generated at block 1206. The BS generates the CRC 1204 based on either CRC polynomial A 1208 or CRC polynomial B 1210. In some aspects, the CRC polynomial A 1208 is associated with a first UE-type configuration, and the CRC polynomial B 1210 is associated with both the first and second UE-type configurations. Accordingly, the BS may transmit the DCI 1202 to UEs having either the first UE-type configuration or the second UE-type configuration by generating the CRC 1204 based on polynomial B. Further, the BS may transmit the DCI 1202 to UEs having the first UE-type configuration only (e.g., UE-initiated COT sharing enabled) so that the UEs having the second UE-type configuration do not detect the DCI 1202.

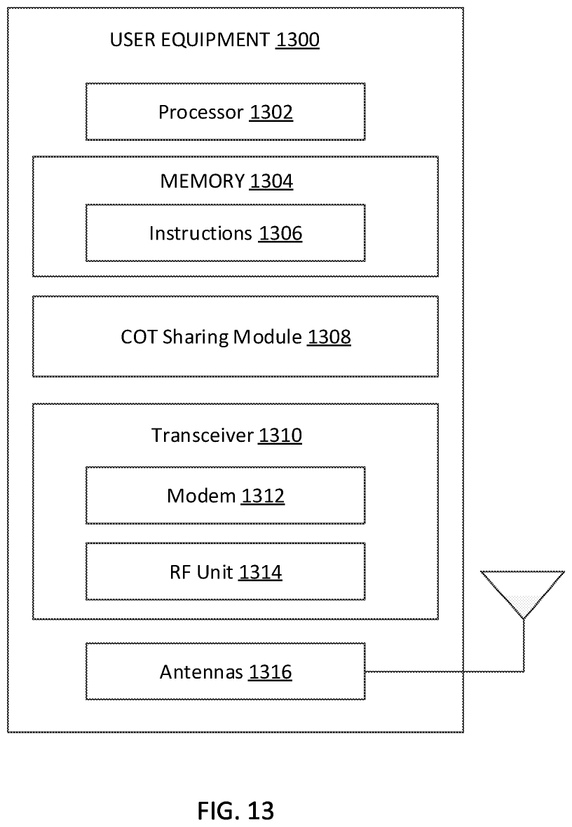

FIG. 13 is a block diagram of an exemplary UE 1300 according to some aspects of the present disclosure. The UE 1300 may be a UE 115 discussed above in FIG. 1. As shown, the UE 1300 may include a processor 1302, a memory 1304, an FBE downlink detection module 1308, a transceiver 1310 including a modem subsystem 1312 and a radio frequency (RF) unit 1314, and one or more antennas 1316. These elements may be coupled with one another. The term “coupled” may refer to directly or indirectly coupled or connected to one or more intervening elements. For instance, these elements may be in direct or indirect communication with each other, for example via one or more buses.

The processor 1302 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 1302 may also be implemented as a combination of computing devices, e.g., a combination of a DSP and a microprocessor, a plurality of microprocessors, one or more microprocessors in conjunction with a DSP core, or any other such configuration.

The memory 1304 may include a cache memory (e.g., a cache memory of the processor 1302), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an aspect, the memory 1304 includes a non-transitory computer-readable medium. The memory 1304 may store, or have recorded thereon, instructions 1306. The instructions 1306 may include instructions that, when executed by the processor 1302, cause the processor 1302 to perform the operations described herein with reference to the UEs 115 in connection with aspects of the present disclosure, for example, aspects of FIGS. 2-7 and 10. Instructions 1306 may also be referred to as program code. The program code may be for causing a wireless communication device to perform these operations, for example by causing one or more processors (such as processor 1302) to control or command the wireless communication device to do so. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The FBE downlink detection module 1308 may be implemented via hardware, software, or combinations thereof. For example, the FBE downlink detection module 1308 may be implemented as a processor, circuit, and/or instructions 1306 stored in the memory 1304 and executed by the processor 1302. In some instances, the FBE downlink detection module 1308 can be integrated within the modem subsystem 1312. For example, the FBE downlink detection module 1308 can be implemented by a combination of software components (e.g., executed by a DSP or a general processor) and hardware components (e.g., logic gates and circuitry) within the modem subsystem 1312.

The FBE downlink detection module 1308 may be used for various aspects of the present disclosure, for example, aspects of aspects of FIGS. 6-12 and 16. The FBE downlink detection module 1308 may be configured to receive a downlink (DL) control channel signal, process the DL control channel signal based on a first UE-type configuration and a second UE-type configuration, and obtain DL control information based on the processing based on the first UE-type configuration or the second UE-type configuration. In some aspects, the FBE downlink detection module 1308 may be configured to obtain a DCI 2_0 based on at least one of the processing. For example, the UE, which may be operating in FBE mode, may monitor for DL control channel signals in a DL control channel, such as a PDCCH, or GC-PDCCH. The DL control channel signal may be transmitted by a BS, and may include a DMRS and encoded and scrambled DCI. The encoding, scrambling, and/or timing (e.g., PDCCH candidate/monitoring occasion) of the DL control channel signal may be associated with a UE-type configuration, and/or with a COT type.

In some aspects, the FBE downlink detection module 1308 is configured to perform a first blind decoding based on a first scrambling ID and a second blind decoding based on a second scrambling ID different from the first scrambling ID. In some aspects, the FBE downlink detection module 1308 is configured to perform a first descrambling based on a first radio network identifier, and a second descrambling based on a second radio network identifier. In some aspects, the FBE downlink detection module 1308 is configured to perform the second descrambling further based a third radio network identifier. According to another aspect, the FBE downlink detection module 1308 is configured to perform a first decoding to obtain a first number of bits, and select a portion of the first number of bits to obtain a DL control information payload. In another aspect, the FBE downlink detection module 1308 is configured to perform an error check based on a first cyclic redundancy check (CRC) polynomial, and perform an error check based on a second CRC polynomial different from the first CRC polynomial.

As shown, the transceiver 1310 may include the modem subsystem 1312 and the RF unit 1314. The transceiver 1310 can be configured to communicate bi-directionally with other devices, such as the BSs 105. The modem subsystem 1312 may be configured to modulate and/or encode the data from the memory 1304 and/or the FBE downlink detection module 1308 according to a modulation and coding scheme (MCS), e.g., a low-density parity check (LDPC) coding scheme, a turbo coding scheme, a convolutional coding scheme, a digital beamforming scheme, etc. The RF unit 1314 may be configured to process (e.g., perform analog to digital conversion or digital to analog conversion, etc.) modulated/encoded data (e.g., PUCCH control information, PRACH signals, PUSCH data) from the modem subsystem 1312 (on outbound transmissions) or of transmissions originating from another source such as another UE 115 or a BS 105. RF unit 1314 can include circuitry such as analog to digital converters, digital to analog converters, filters, amplifiers, etc. The RF unit 1314 may be further configured to perform analog beamforming in conjunction with the digital beamforming. Although shown as integrated together in transceiver 1310, the modem subsystem 1312 and the RF unit 1314 may be separate devices that are coupled together at the UE 115 to enable the UE 115 to communicate with other devices.

The RF unit 1314 may provide the modulated and/or processed data, e.g. data packets (or, more generally, data messages that may contain one or more data packets and other information), to the antennas 1316 for transmission to one or more other devices. The antennas 1316 may further receive data messages transmitted from other devices. The antennas 1316 may provide the received data messages for processing and/or demodulation at the transceiver 1310. The transceiver 1310 may provide the demodulated and decoded data (e.g., DCI, such as DCI 2_0, SSBs, RMSI, MIB, SIB, FBE configuration, PRACH configuration PDCCH, GC-PDCCH, PDSCH) to the FBE downlink detection module 1308 for processing. The antennas 1316 may include multiple antennas of similar or different designs in order to sustain multiple transmission links. The RF unit 1314 may configure the antennas 1316.

In an aspect, the UE 1300 can include multiple transceivers 1310 implementing different RATs (e.g., NR and LTE). In an aspect, the UE 1300 can include a single transceiver 1310 implementing multiple RATs (e.g., NR and LTE). In an aspect, the transceiver 1310 can include various components, where different combinations of components can implement different RATs.

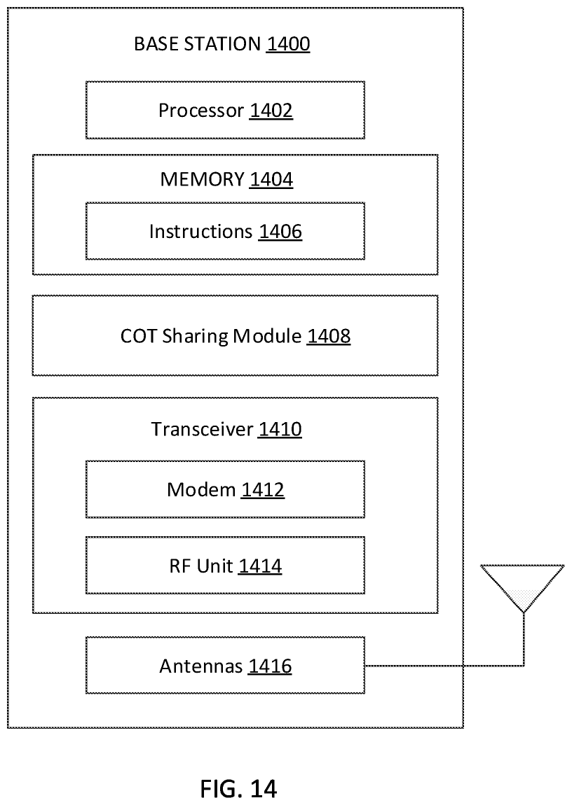

FIG. 14 is a block diagram of an exemplary BS 1400 according to some aspects of the present disclosure. The BS 1400 may be a BS 105 in the network 100 as discussed above in FIGS. 1 and 3A. A shown, the BS 1400 may include a processor 1402, a memory 1404, an FBE downlink control transmission module 1408, a transceiver 1410 including a modem subsystem 1412 and a RF unit 1414, and one or more antennas 1416. These elements may be coupled with one another. The term “coupled” may refer to directly or indirectly coupled or connected to one or more intervening elements. For instance, these elements may be in direct or indirect communication with each other, for example via one or more buses.

The processor 1402 may have various features as a specific-type processor. For example, these may include a CPU, a DSP, an ASIC, a controller, a FPGA device, another hardware device, a firmware device, or any combination thereof configured to perform the operations described herein. The processor 1402 may also be implemented as a combination of computing devices, e.g., a combination of a DSP and a microprocessor, a plurality of microprocessors, one or more microprocessors in conjunction with a DSP core, or any other such configuration.

The memory 1404 may include a cache memory (e.g., a cache memory of the processor 1402), RAM, MRAM, ROM, PROM, EPROM, EEPROM, flash memory, a solid state memory device, one or more hard disk drives, memristor-based arrays, other forms of volatile and non-volatile memory, or a combination of different types of memory. In some aspects, the memory 1404 may include a non-transitory computer-readable medium. The memory 1404 may store instructions 1406. The instructions 1406 may include instructions that, when executed by the processor 1402, cause the processor 1402 to perform operations described herein, for example, aspects of FIGS. 2-7 and 11. Instructions 1406 may also be referred to as code, which may be interpreted broadly to include any type of computer-readable statement(s) as discussed above.

The FBE downlink control transmission module 1408 may be implemented via hardware, software, or combinations thereof. For example, the FBE downlink control transmission module 1408 may be implemented as a processor, circuit, and/or instructions 1406 stored in the memory 1404 and executed by the processor 1402. In some instances, the FBE downlink control transmission module 1408 can be integrated within the modem subsystem 1412. For example, the FBE downlink control transmission module 1408 can be implemented by a combination of software components (e.g., executed by a DSP or a general processor) and hardware components (e.g., logic gates and circuitry) within the modem subsystem 1412.

The FBE downlink control transmission module 1408 may be used for various aspects of the present disclosure, for example, aspects of aspects of FIGS. 6-12 and 15. The FBE downlink control transmission module 1408 can be configured to transmit, based on a first configuration during a first period, a first downlink (DL) control signal, wherein the first configuration is based on the first period associated with a first channel occupancy signal (COT) type. The FBE downlink control transmission module 1408 may be further configured to transmit, based on a second configuration during a second period, a second DL control signal, wherein the second configuration is based on the second period associated with a second COT type different from the first COT type, and wherein the second configuration is different from the first configuration. In some aspects, FBE downlink control transmission module 1408 is configured to transmit a DCI in a GC-PDCCH, where the DCI is scrambled using a DMRS scrambling ID associated with the first period and/or with a first UE-type configuration.

In some aspects, the FBE downlink control transmission module 1408 is configured to transmit the second DL control signal based on the second scrambling identity. In some aspects, the first period is associated with a DL control channel monitoring occasion for a first user equipment (UE) type, and the second period is associated with a DL control channel monitoring occasion for a second UE type different from the first UE type.

In some aspects, the FBE downlink control transmission module 1408 is configured to transmit the first DL control signal based on a first UE-type configuration and a second UE-type configuration different from the first UE-type configuration, and to transmit the second DL control signal based on the second configuration. In some aspects, the FBE downlink control transmission module 1408 is configured to transmit the second DL control signal based on the second radio network identifier including the first radio network identifier and a third radio network identifier different from the first radio network identifier. In some aspects, the FBE downlink control transmission module 1408 is configured to transmit a first downlink control information (DCI) comprising a first number of bits, and to transmit a second DCI comprising a second number of bits different from the first number of bits. In some aspects, the FBE downlink control transmission module 1408 is configured to transmit the first DL control signal based on a first cyclic redundancy check (CRC) polynomial, and to transmit the second DL control signal based on a second CRC polynomial different from the first CRC polynomial.

As shown, the transceiver 1410 may include the modem subsystem 1412 and the RF unit 1414. The transceiver 1410 can be configured to communicate bi-directionally with other devices, such as the UEs 115 and/or 800, another BS 105, and/or another core network element. The modem subsystem 1412 may be configured to modulate and/or encode data according to a MCS, e.g., a LDPC coding scheme, a turbo coding scheme, a convolutional coding scheme, a digital beamforming scheme, etc. The RF unit 1414 may be configured to process (e.g., perform analog to digital conversion or digital to analog conversion, etc.) modulated/encoded data (e.g., SSBs, RMSI, MIB, SIB, FBE configuration, PRACH configuration PDCCH, GC-PDCCH, DCI, PDSCH) from the modem subsystem 1412 (on outbound transmissions) or of transmissions originating from another source, such as a UE 115. RF unit 1414 can include circuitry such as analog to digital converters, digital to analog converters, filters, amplifiers, etc. The RF unit 1414 may be further configured to perform analog beamforming in conjunction with the digital beamforming. Although shown as integrated together in transceiver 1410, the modem subsystem 1412 and/or the RF unit 1414 may be separate devices that are coupled together at the BS 105 to enable the BS 105 to communicate with other devices.

The RF unit 1414 may provide the modulated and/or processed data, e.g. data packets (or, more generally, data messages that may contain one or more data packets and other information), to the antennas 1416 for transmission to one or more other devices. The antennas 1416 may further receive data messages transmitted from other devices and provide the received data messages for processing and/or demodulation at the transceiver 1410. The transceiver 1410 may provide the demodulated and decoded data (e.g., PUCCH control information, PRACH signals, PUSCH data) to the FBE downlink control transmission module 1408 for processing. The antennas 1416 may include multiple antennas of similar or different designs in order to sustain multiple transmission links.

In an aspect, the BS 1400 can include multiple transceivers 1410 implementing different RATs (e.g., NR and LTE). In an aspect, the BS 1400 can include a single transceiver 1410 implementing multiple RATs (e.g., NR and LTE). In an aspect, the transceiver 1410 can include various components, where different combinations of components can implement different RATs.

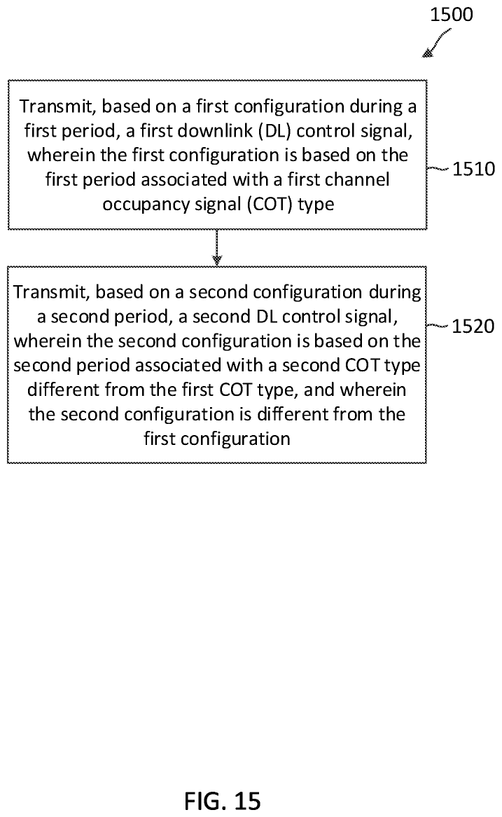

FIG. 15 is a flow diagram of a communication method 1500 according to some aspects of the present disclosure. Steps of the method 1500 can be executed by a computing device (e.g., a processor, processing circuit, and/or other suitable component) of an apparatus or other suitable means for performing the steps. For example, a BS, such as a BS 105, 605, and/or 1400, may utilize one or more components, such as the processor 1402, the memory 1404, the FBE downlink control transmission module 1408, the transceiver 1410, and the one or more antennas 1416, to execute the steps of method 1500. The method 1500 may employ similar mechanisms as described above with respect to FIGS. 6-12. As illustrated, the method 1500 includes a number of enumerated steps, but aspects of the method 1500 may include additional steps before, after, and in between the enumerated steps. In some aspects, one or more of the enumerated steps may be omitted or performed in a different order.

At block 1510, the BS transmits, based on a first configuration during a first period, a first downlink (DL) control signal, wherein the first configuration is based on the first period associated with a first channel occupancy signal (COT) type. In some aspects, the transmitting the first DL control signal comprises: transmitting a third DL control signal based on a first scrambling identity; and transmitting a fourth DL control signal based on a second scrambling identity different from the first scrambling identity. In some aspects, block 1510 includes transmitting a DCI in a GC-PDCCH, where the DCI is scrambled using a DMRS scrambling ID associated with the first period and/or with a first UE-type configuration. The BS may use one or more components to perform the actions at block 1510, including the processor 1402, the memory 1404, the FBE downlink control transmission module 1408, the transceiver 1410, and the one or more antennas 1416, to execute the actions of block 1510.

At block 1520, the BS transmits, based on a second configuration during a second period, a second DL control signal, wherein the second configuration is based on the second period associated with a second COT type different from the first COT type, and wherein the second configuration is different from the first configuration. In some aspects, the transmitting the second DL control signal comprises transmitting the second DL control signal based on the second scrambling identity. In some aspects, the first period is associated with a DL control channel monitoring occasion for a first user equipment (UE) type, and the second period is associated with a DL control channel monitoring occasion for a second UE type different from the first UE type. The BS may use one or more components to perform the actions at block 1510, including the processor 1402, the memory 1404, the FBE downlink control transmission module 1408, the transceiver 1410, and the one or more antennas 1416, to execute the actions of block 1520.

In some aspects, the transmitting the first DL control signal comprises transmitting the first DL control signal based on a first UE-type configuration and a second UE-type configuration different from the first UE-type configuration, and the transmitting the second DL control signal comprises transmitting the second DL control signal based on the second configuration. In some aspects, the transmitting the second DL control signal is based on the second radio network identifier including the first radio network identifier and a third radio network identifier different from the first radio network identifier. In other aspects, the transmitting the first DL control signal comprises transmitting a first downlink control information (DCI) comprising a first number of bits, and the transmitting the second DL control signal comprises transmitting a second DCI comprising a second number of bits different from the first number of bits. In some aspects, the transmitting the first DL control signal comprises transmitting the first DL control signal based on a first cyclic redundancy check (CRC) polynomial, and the transmitting the second DL control signal comprises transmitting the second DL control signal based on a second CRC polynomial different from the first CRC polynomial.

In some aspects, the transmitting the first DL control signal comprises transmitting a first group-common physical downlink control channel (GC-PDCCH) communication, and the transmitting the second DL control signal comprises transmitting a second GC-PDCCH communication. In some aspects, the first COT type is a BS-acquired COT type, and wherein the second COT type is a user-equipment (UE)-acquired COT type.

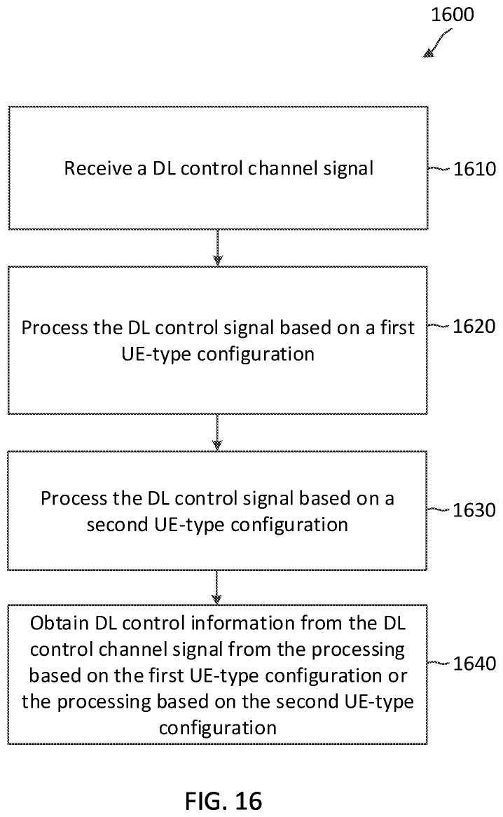

FIG. 16 is a flow diagram of a communication method 1600 according to some aspects of the present disclosure. Steps of the method 1600 can be executed by a computing device (e.g., a processor, processing circuit, and/or other suitable component) of an apparatus or other suitable means for performing the steps. For example, a UE, such as the UEs 115, 615, and/or 1300, may utilize one or more components, such as the processor 1302, the memory 1304, the FBE downlink detection module 1308, the transceiver 1310, and the one or more antennas 1316, to execute the steps of method 1600. The method 1600 may employ similar mechanisms as described above with respect to FIGS. 6-12. As illustrated, the method 1600 includes a number of enumerated steps, but aspects of the method 1600 may include additional steps before, after, and in between the enumerated steps. In some aspects, one or more of the enumerated steps may be omitted or performed in a different order.

At block 1610, the UE receives a downlink (DL) control channel signal. For example, the UE, which may be operating in FBE mode, may monitor for DL control channel signals in DL control channel resources, such as PDCCHs, or GC-PDCCHs. The DL control channel signal may be transmitted by a BS, and may include a DMRS and encoded and scrambled DCI. The encoding, scrambling, or timing (e.g., PDCCH candidate/monitoring occasion) of the DL control channel signal may be associated with a UE-type configuration, and/or with a COT type. The UE may utilize one or more components, such as the processor 1302, the memory 1304, the FBE downlink detection module 1308, the transceiver 1310, and the one or more antennas 1316, to execute the actions of block 1610.

At block 1620, the UE processes the DL control channel signal based on a first UE-type configuration. In some aspects, the first UE-type configuration may be referred to as an enhanced configuration, and may configure the UE to share a portion of a UE-initiated COT with a BS in FBE mode. In some aspects, the first UE-type configuration may also configure the UE to detect or determine a DL transmission identifier in a DL control channel signal indicating whether a received communication is transmitted in a BS-acquired COT. In some aspects, processing the DL control channel signal based on the first UE-type configuration includes performing a first blind decoding operation in a PDCCH monitoring occasion using a first scrambling ID (e.g., a DMRS scrambling ID). The UE may utilize one or more components, such as the processor 1302, the memory 1304, the FBE downlink detection module 1308, the transceiver 1310, and the one or more antennas 1316, to execute the actions of block 1620.

At block 1630, the UE processes the DL control channel signal based on a second UE-type configuration different from the first UE-type configuration. In some aspects, the second UE-type configuration may be a 3GPP Release 16 UE configuration. In some aspects, the second UE-type configuration may not configure the UE to share a portion of a UE-acquired COT with a BS in FBE mode. Further, in some aspects, the second UE-type configuration may not configure the UE to detect or determine whether a received communication is transmitted in a BS-acquired COT. In some aspects, processing the DL control channel signal based on the first UE-type configuration includes performing a second blind decoding operation in a PDCCH monitoring occasion using a second scrambling ID (e.g., a DMRS scrambling ID). The UE may utilize one or more components, such as the processor 1302, the memory 1304, the FBE downlink detection module 1308, the transceiver 1310, and the one or more antennas 1316, to execute the actions of block 1630.

At block 1640, the UE obtains DL control information form the DL control channel signal form the processing based on the first UE-type configuration or the processing based on the second UE-type configuration. In some aspects, the UE may obtain a DCI 2_0 based on at least one of the processing at block 1620 or the processing at block 1630. In some aspects, the UE may perform a single decoding or monitoring operation, and the processing based on the first UE-type configuration may include descrambling using a first RNTI, and the processing based on the second UE-type configuration may include descrambling using a second RNTI different from the RNTI. In other aspects, the processing based on the first UE-type configuration may include descrambling using a first RNTI, and the processing based on the second UE-type configuration may include descrambling using a second RNTI different from the RNTI. The UE may utilize one or more components, such as the processor 1302, the memory 1304, the FBE downlink detection module 1308, the transceiver 1310, and the one or more antennas 1316, to execute the actions of block 1640.

In some aspects, the processing the DL control channel signal based on the first UE-type configuration comprises a first blind decoding, and the processing the DL control channel signal based on the second UE-type configuration comprises a second blind decoding. In some aspects, the processing the DL control channel signal based on the first UE-type configuration comprises a first descrambling based on a first radio network identifier, and the processing the DL control channel signal based on the second UE-type configuration comprises a second descrambling based on a second radio network identifier. The second descrambling may be further based a third radio network identifier, in some aspects. According to another aspect, the processing the DL control channel signal based on the first UE-type configuration may include a first decoding to obtain a first number of bits, and the processing the DL control channel signal based on the second UE-type configuration may include selecting a portion of the first number of bits. In another aspect, the processing the DL control channel signal based on the first UE-type configuration comprises performing an error check based on a first cyclic redundancy check (CRC) polynomial, and the processing the DL control channel signal based on the second UE-type configuration comprises performing an error check based on a second CRC polynomial different from the first CRC polynomial.

Other aspects of the present disclosure include the following:
1. A method for wireless communication performed by a base station (BS), the method comprising:
   transmitting, based on a first configuration during a first period, a first downlink (DL) control signal, wherein the first configuration is based on the first period associated with a first channel occupancy signal (COT) type; and
   transmitting, based on a second configuration during a second period, a second DL control signal, wherein the second configuration is based on the second period associated with a second COT type different from the first COT type, and wherein the second configuration is different from the first configuration.
2. The method of clause 1,
   wherein the transmitting the first DL control signal comprises:
      transmitting a third DL control signal based on a first scrambling identity; and
      transmitting a fourth DL control signal based on a second scrambling identity different from the first scrambling identity.
3. The method of clause 2, wherein the transmitting the second DL control signal comprises transmitting the second DL control signal based on the second scrambling identity.
4. The method of any of clauses 1-2,
   wherein the first period is associated with a DL control channel monitoring occasion for a first user equipment (UE) type, and
   wherein the second period is associated with a DL control channel monitoring occasion for a second UE type different from the first UE type.
5. The method of clause 1,
   wherein the transmitting the first DL control signal comprises transmitting the first DL control signal based on a first UE-type configuration and a second UE-type configuration different from the first UE-type configuration, and
   wherein the transmitting the second DL control signal comprises transmitting the second DL control signal based on the second configuration.
6. The method of any of clauses 1 and 5
   wherein the transmitting the first DL control signal comprises transmitting the first DL control signal based on a first radio network identifier, and
   wherein the transmitting the second DL control signal comprises transmitting the second DL control signal based on a second radio network identifier different from the first radio network identifier.
7. The method of clause 6, wherein the transmitting the second DL control signal is based on the second radio network identifier including the first radio network identifier and a third radio network identifier different from the first radio network identifier.
8. The method of any of clauses 1 and 5-7,
   wherein the transmitting the first DL control signal comprises transmitting a first downlink control information (DCI) comprising a first number of bits, and
   wherein the transmitting the second DL control signal comprises transmitting a second DCI comprising a second number of bits different from the first number of bits.
9. The method of any of clauses 1 and 5-8,
   wherein the transmitting the first DL control signal comprises transmitting the first DL control signal based on a first cyclic redundancy check (CRC) polynomial, and
   wherein the transmitting the second DL control signal comprises transmitting the second DL control signal based on a second CRC polynomial different from the first CRC polynomial.
10. The method of any of clauses 1-9,
   wherein the transmitting the first DL control signal comprises transmitting a first group-common physical downlink control channel (GC-PDCCH) communication, and
   wherein the transmitting the second DL control signal comprises transmitting a second GC-PDCCH communication.
11. The method of any of clauses 1-10, wherein the first COT type is a BS-acquired COT type, and wherein the second COT type is a user-equipment (UE)-acquired COT type.
12. A method for wireless communication performed by a user equipment (UE), the method comprising:
   receiving a downlink (DL) control channel signal;
   processing the DL control channel signal based on a first user equipment (UE)-type configuration;
   processing the DL control channel signal based on a second UE-type configuration different from the first UE-type configuration; and
   obtaining DL control information from the DL control channel signal from the processing based on the first UE-type configuration or the processing based on the second UE-type configuration.
13. The method of clause 12,
   wherein the processing the DL control channel signal based on the first UE-type configuration comprises a first blind decoding, and
   wherein the processing the DL control channel signal based on the second UE-type configuration comprises a second blind decoding.
14. The method of clause 12,
   wherein the processing the DL control channel signal based on the first UE-type configuration comprises a first descrambling based on a first radio network identifier, and
   wherein the processing the DL control channel signal based on the second UE-type configuration comprises a second descrambling based on a second radio network identifier.
15. The method of clause 14, wherein the second descrambling is further based a third radio network identifier.
16. The method of any of clauses 12 and 14,
   wherein the processing the DL control channel signal based on the first UE-type configuration comprises a first decoding to obtain a first number of bits, and
   wherein the processing the DL control channel signal based on the second UE-type configuration comprises selecting a portion of the first number of bits.
17. The method of clause 12,
   wherein the processing the DL control channel signal based on the first UE-type configuration comprises performing an error check based on a first cyclic redundancy check (CRC) polynomial, and
   wherein the processing the DL control channel signal based on the second UE-type configuration comprises performing an error check based on a second CRC polynomial different from the first CRC polynomial.

One aspect includes an apparatus comprising a processor coupled to a transceiver, wherein the processor and transceiver are configured to perform the method of any one of clauses 1-17.

Another aspect includes an apparatus comprising means for performing the method of any one of clauses 1-17.

Another aspect includes a non-transitory computer readable medium including program code, which when executed by one or more processors, causes a wireless communication device to perform the method of any one of clauses 1-17.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular aspects illustrated and described herein, as they are merely by way of some examples thereof, but rather, should be fully commensurate with that of the claims appended hereafter and their functional equivalents.

1. A method for wireless communication performed by a base station (BS), the method comprising:
transmitting, based on a first configuration during a first period, a first downlink (DL) control signal, wherein the first configuration is based on the first period associated with a first channel occupancy signal (COT) type; and
transmitting, based on a second configuration during a second period, a second DL control signal, wherein the second configuration is based on the second period associated with a second COT type different from the first COT type, and wherein the second configuration is different from the first configuration.

2. The method of claim 1,
wherein the transmitting the first DL control signal comprises:
transmitting a third DL control signal based on a first scrambling identity; and
transmitting a fourth DL control signal based on a second scrambling identity different from the first scrambling identity.

3. The method of claim 2, wherein the transmitting the second DL control signal comprises transmitting the second DL control signal based on the second scrambling identity.

4. The method of claim 1,
wherein the first period is associated with a DL control channel monitoring occasion for a first user equipment (UE) type, and
wherein the second period is associated with a DL control channel monitoring occasion for a second UE type different from the first UE type.

5. The method of claim 1,
wherein the transmitting the first DL control signal comprises transmitting the first DL control signal based on a first UE-type configuration and a second UE-type configuration different from the first UE-type configuration, and
wherein transmitting the second DL control signal comprises transmitting the second DL control signal based on the second configuration.

6. The method of claim 1,
wherein the transmitting the first DL control signal comprises transmitting the first DL control signal based on a first radio network identifier, and
wherein transmitting the second DL control signal comprises transmitting the second DL control signal based on a second radio network identifier different from the first radio network identifier.

7. The method of claim 6, wherein the transmitting the second DL control signal is based on the second radio network identifier including the first radio network identifier and a third radio network identifier different from the first radio network identifier.

8. The method of claim 1,
wherein the transmitting the first DL control signal comprises transmitting a first downlink control information (DCI) comprising a first number of bits, and
wherein the transmitting the second DL control signal comprises transmitting a second DCI comprising a second number of bits different from the first number of bits.

9. The method of claim 1,
wherein the transmitting the first DL control signal comprises transmitting the first DL control signal based on a first cyclic redundancy check (CRC) polynomial, and
wherein transmitting the second DL control signal comprises transmitting the second DL control signal based on a second CRC polynomial different from the first CRC polynomial.

10. The method of claim 1,
wherein the transmitting the first DL control signal comprises transmitting a first group-common physical downlink control channel (GC-PDCCH) communication, and
wherein the transmitting the second DL control signal comprises transmitting a second GC-PDCCH communication.

11. The method of claim 1, wherein the first COT type is a BS-acquired COT type, and wherein the second COT type is a user-equipment (UE)-acquired COT type.

12. A method for wireless communication performed by a user equipment (UE), the method comprising:
receiving a downlink (DL) control channel signal;
processing the DL control channel signal based on a first user equipment (UE)-type configuration;
processing the DL control channel signal based on a second UE-type configuration different from the first UE-type configuration; and
obtaining DL control information from the DL control channel signal from the processing based on the first UE-type configuration or the processing based on the second UE-type configuration.

13. The method of claim 12,
wherein the processing the DL control channel signal based on the first UE-type configuration comprises a first blind decoding, and
wherein the processing the DL control channel signal based on the second UE-type configuration comprises a second blind decoding.

14. The method of claim 12,
wherein the processing the DL control channel signal based on the first UE-type configuration comprises a first descrambling based on a first radio network identifier, and
wherein the processing the DL control channel signal based on the second UE-type configuration comprises a second descrambling based on a second radio network identifier.

15. The method of claim 14, wherein the second descrambling is further based a third radio network identifier.

16. The method of claim 12,
wherein the processing the DL control channel signal based on the first UE-type configuration comprises a first decoding to obtain a first number of bits, and
wherein the processing the DL control channel signal based on the second UE-type configuration comprises selecting a portion of the first number of bits.

17. The method of claim 12,
wherein the processing the DL control channel signal based on the first UE-type configuration comprises performing an error check based on a first cyclic redundancy check (CRC) polynomial, and
wherein the processing the DL control channel signal based on the second UE-type configuration comprises performing an error check based on a second CRC polynomial different from the first CRC polynomial.

18. A base station (BS), comprising:
a transceiver; and
a processor in communication with the transceiver and configured to cause the transceiver to:
transmit, based on a first configuration during a first period, a first downlink (DL) control signal, wherein the first configuration is based on the first period associated with a first channel occupancy signal (COT) type; and
transmit, based on a second configuration during a second period, a second DL control signal, wherein the second configuration is based on the second period associated with a second COT type different from the first COT type, and wherein the second configuration is different from the first configuration.

19. The BS of claim 18,
wherein the processor configured to cause the transceiver to transmit the first DL control signal comprises the processor configured to cause the transceiver to:
transmit a third DL control signal based on a first scrambling identity; and
transmit a fourth DL control signal based on a second scrambling identity different from the first scrambling identity.

20. The BS of claim 19, wherein the processor configured to cause the transceiver to transmit the second DL control signal comprises the processor configured to cause the transceiver to transmit the second DL control signal based on the second scrambling identity.

21. The BS of claim 18,
wherein the first period is associated with a DL control channel monitoring occasion for a first user equipment (UE) type, and
wherein the second period is associated with a DL control channel monitoring occasion for a second UE type different from the first UE type.

22. The BS of claim 18,
wherein the processor is configured to cause the transceiver to transmit the first DL control signal based on a first radio network identifier, and
wherein the processor is configured to cause the transceiver to transmit the second DL control signal based on a second radio network identifier different from the first radio network identifier.

23. The BS of claim 18,
wherein the processor is configured to cause the transceiver to transmit the first DL control signal comprises the processor configured to cause the transceiver to transmit a first downlink control information (DCI) comprising a first number of bits, and
wherein the processor configured to cause the transceiver to transmit the second DL control signal comprises the processor configured to cause the transceiver to transmit a second DCI comprising a second number of bits different from the first number of bits.

24. The BS of claim 18,
wherein the processor is configured to cause the transceiver to transmit the first DL control signal based on a first cyclic redundancy check (CRC) polynomial, and
wherein the processor is configured to cause the transceiver to transmit the second DL control signal based on a second CRC polynomial different from the first CRC polynomial.

25. A user equipment (UE), comprising:
a transceiver; and
a processor in communication with the transceiver and configured to cause the transceiver to:
receive a downlink (DL) control channel signal,
wherein the processor is further configured to:
process the DL control channel signal based on a first user equipment (UE)-type configuration;
process the DL control channel signal based on a second UE-type configuration different from the first UE-type configuration; and
obtain DL control information from the DL control channel signal from the processing based on the first UE-type configuration or the processing based on the second UE-type configuration.

26. The UE of claim 25,
wherein the processor configured to process the DL control channel signal based on the first UE-type configuration comprises the processor configured to perform a first blind decoding, and
wherein the processor configured to process the DL control channel signal based on the second UE-type configuration comprises the processor configured to perform a second blind decoding.

27. The UE of claim 25,
wherein the processor configured to process the DL control channel signal based on the first UE-type configuration comprises the processor configured to perform a first descrambling based on a first radio network identifier, and
wherein the processor configured to process the DL control channel signal based on the second UE-type configuration comprises the processor configured to perform a second descrambling based on a second radio network identifier.

28. The UE of claim 27, wherein the processor is configured to perform the second descrambling further based a third radio network identifier.

29. The UE of claim 25,
wherein the processor configured to process the DL control channel signal based on the first UE-type configuration comprises the processor configured to perform a first decoding to obtain a first number of bits, and
wherein the processor configured to process the DL control channel signal based on the second UE-type configuration comprises the processor configured to select a portion of the first number of bits.

30. The UE of claim 25,
wherein the processor configured to process the DL control channel signal based on the first UE-type configuration comprises the processor configured to perform an error check based on a first cyclic redundancy check (CRC) polynomial, and
wherein the processor configured to process the DL control channel signal based on the second UE-type configuration comprises the processor configured to perform an error check based on a second CRC polynomial different from the first CRC polynomial.
